(19) United States
(12) Patent Application Publication
(10) Pub. No.: US 2026/0088525 A1
(43) Pub. Date: Mar. 26, 2026

(54) ELECTRICAL CLAMPS WITH BONDING STRUCTURES

(71) Applicant: Hubbell Incorporated, Shelton, CT (US)

(72) Inventors: Sarah J. Parsons, Hudson, NH (US); Samuel Jackson Carbonneau, Goffstown, NH (US)

(21) Appl. No.: 19/338,615

(22) Filed: Sep. 24, 2025

Related U.S. Application Data
(60) Provisional application No. 63/698,746, filed on Sep. 25, 2024.

(51) Int. Cl. H01R 4/2408; H01R 4/2407; H01R 4/46; H01R 4/66

(52) U.S. Cl. CPC H01R 4/2408; H01R 4/2407; H01R 4/46; H01R 4/66

(57) ABSTRACT

The present disclosure provides descriptions of clamps with bonding features used to facilitate the electrical bonding of metal structures, such as helical pile shafts. The clamp includes a base, a main body having at least one piercing member, and a clamping member. The base and main body come together to receive at least a portion of one or more grounding elements and to receive at least a portion of a structure. The at least one piercing member is positioned to pierce any coating of the structure when the clamp is tightened.

### CROSS-REFERENCE TO RELATED APPLICATIONS

This application is based on and claims benefit from co-pending U.S. Provisional Patent Application No. 63/698,746 filed on Sep. 25, 2024 entitled “Electrical Clamps with Bonding Structures” the contents of which are incorporated herein in its entirety by reference.

### FIELD

The present disclosure relates generally to bonding clamps, and more particularly to bonding clamps used to create an electrically conductive path between one or more grounding elements and a metal structure coated with a non-conductive material.

### DESCRIPTION OF THE RELATED ART

Often, metal structures such as helical piles shafts, fence posts, pipes and other structures need to be connected to a grounding system to properly dissipate electrical charge on such metal structures. One way to ground such metal structures is to attach electrical clamps to the metal structures and to secure a ground conductor to the electrical clamp. The ground conductor is then connected to a ground system that may include a ground rod inserted into the earth.

In certain environments, the metal structures may be coated with an environmental resistant material to protect the metal structures from environmental conditions and to limit and possibly prevent the metal structure from corrosion. The protective coating is typically a thin layer of environmental resistant material typically in the range of about 0.1 mm and about 2 mm in thickness. Non-limiting examples of such environmental resistant materials include powder coating, certain paints and certain epoxy materials. However, such environmental resistant materials may not be electrically conductive, which makes it difficult to have an electrical connection between the electrical clamp and the metal structures beneath such environmental resistant materials without first removing the protective coating. Stripping or removing the protective coating is a time-consuming process and may also strip off more of the coating material than necessary leading to an increased risk of corrosion to the metal structure or necessitating remedial measures to ensure that the exposed metal is protected from the environment.

Therefore, it is desirable to provide an electrical clamp that can connect to metal structures having a protective coating to a ground conductor and that can electrically bond the metal structure to the ground conductor without the need to strip or remove the protective coating on the metal structure. The electrical clamps according to the present disclosure are quick and easy to install in a cost-efficient manner.

### SUMMARY OF THE DISCLOSURE

The present disclosure provides descriptions of embodiments for clamp assemblies used to facilitate electrical bonding of metal structures without the need to grind or sand protective coatings to expose bare metal. In one exemplary embodiment, the clamp assembly includes a clamping member, a base and a main body. The base includes a conductor gripping member. The main body includes a conductor gripping member and at least one piercing member extending away from the main body. The clamping member is configured to receive at least a portion of the metal structure to which the clamp assembly is attached and couples the base and the main body together such that the conductor gripping member of the base and the conductor gripping member of the main body are aligned to form a conductor channel. The at least one piercing member extends from the main body and is used to pierce or cut through any protective coating on the exterior of the structure the clamp assembly is attached to. The positions of the base and the main body relative to one another and relative to the clamping member are adjustable to permit the clamp assembly to receive different sizes of grounding elements and metal structures.

In another exemplary embodiment, the clamp assembly includes a clamping member, a base, a main body and a bonding member. The base includes a conductor gripping member. The main body includes a conductor gripping member. The bonding member includes at least one piercing member extending therefrom. The bonding member is coupled, attached or secured, either removably or permanently, to the main body via one or more coupling members. The coupling members may be arms, legs or other members that extend from a body of the bonding member and are configured to removably or permanently attach, couple or otherwise secure the bonding member to the main body. In this embodiment, the coupling members are arms configured to fold such that the folded portion of the arms are in contact with the main body so as to removably or permanently attach, couple or otherwise secure the bonding member to the main body. The at least one piercing member is used to pierce or cut through any protective coating on the metal structure the clamp assembly is attached to. The clamping member is configured to receive at least a portion of the metal structure to which the clamp assembly is attached and couples the base and main body together and to the metal structure. When the conductor gripping member of the base and the conductor gripping member of the main body are aligned a conductor channel is formed. The positions of the base and the main body relative to one another and relative to the clamping member are adjustable to permit the clamp assembly to receive different sizes of grounding elements and metal structures.

In another exemplary embodiment, the clamp assembly includes a clamping member, a base, a main body and a bonding member. The base includes a conductor gripping member, and the main body includes a conductor gripping member. The bonding member is coupled, attached or secured, either removably or permanently, to the main body via one or more coupling members. The bonding member includes at least one piercing member extending from a body of the bonding member. The coupling members may include a protrusion extending away from the main body and an aperture through the bonding member configured to receive at least a portion of the protrusion. Applying a force to the protrusion deforms the protrusion such that the bonding member becomes attached, coupled or secured to the main body. The at least one piercing member is used to pierce or cut through any protective coating on the metal structure the clamp assembly is attached to. The clamping member is configured to receive at least a portion of the metal structure to which the clamp assembly is attached and couples the base and the main body together and to the metal structure. When the base and main body are in contact such that the conductor gripping member of the base and the conductor gripping member of the main body are aligned a conductor channel is formed. The positions of the base and the main body relative to one another and relative to the clamping member are adjustable to permit the clamp assembly to receive different sizes of grounding elements and metal structures.

In another exemplary embodiment, the clamp assembly includes a clamping member, a base, a main body and a bonding member. The bonding member includes at least one piercing member extending therefrom. The at least one piercing member is used to pierce or cut through any coating on the exterior of the metal structure the clamp assembly is attached to. The bonding member is attached, coupled or secured, either removably or permanently, to the main body via one or more coupling members. The one or more coupling members may be one or more pairs of legs that extend from the bonding member and are configured to removably or permanently attach, couple or otherwise secure the bonding member to the main body. In this embodiment, the each coupling member includes a pair of legs configured to flex such that they may pass through a corresponding channel or slot in the main body so as to removably or permanently attach, couple or otherwise secure the bonding member to the main body. The clamping member is configured to receive at least a portion of the metal structure to which the clamp assembly is attached and couples the base and the main body together and to the metal structure. The positions of the base and the main body relative to one another and relative to the clamping member are adjustable to permit the clamp assembly to receive different sizes of grounding elements and structures.

In another exemplary embodiment, the clamp assembly includes a clamping member, a base, a main body and a bonding member. The bonding member includes at least one piercing member extending therefrom. The bonding member is attached, coupled or secured, either removably or permanently, to the main body via one or more coupling members. The one or more coupling members may be legs or other members that extend from the bonding member and are configured to removably or permanently attach, couple or otherwise secure the bonding member to the main body. In this embodiment, the one or more coupling members are legs configured to be inserted through a corresponding channel or slot in the main body and to fold such that the folded portion of the legs are in contact with the main body so as to removably or permanently attach, couple or otherwise secure the bonding member to the main body. The at least one piercing member is used to pierce or cut through any protective coating on the metal structure the clamp assembly is attached to. The clamping member is configured to receive at least a portion of the metal structure to which the clamp assembly is attached and couples the base and the main body together and to the metal structure. The positions of the base and the main body relative to one another and relative to the clamping member are adjustable to permit the clamp assembly to receive different sizes of grounding elements and metal structures.

In another exemplary embodiment, the clamp assembly includes a clamping member, a base, a main body and a bonding member. The bonding member includes at least one piercing member extending therefrom. The bonding member is attached, coupled or secured, either removably or permanently, to the main body via one or more coupling members. The one or more coupling members may be legs or other members that extend from one or more side edges of a body of the bonding member and are configured to removably or permanently attach, couple or otherwise secure the bonding member to the main body. In this embodiment, the one or more coupling members are legs extending from the side edges of the bonding member and configured to engage a slot or channel on a side wall of the main body so as to removably or permanently attach, couple or otherwise secure the bonding member to the main body. The at least one piercing member is used to pierce or cut through any protective coating on the metal structure the clamp assembly is attached to. The clamping member is configured to receive at least a portion of the metal structure to which the clamp assembly is attached and couples the base and the main body together. The positions of the base and the main body relative to one another and relative to the clamping member are adjustable to permit the clamp assembly to receive different sizes of grounding elements and metal structures.

In another exemplary embodiment, the clamp assembly includes a clamping member, a base, a main body and a bonding member. The bonding member includes at least one piercing member extending therefrom. The at least one piercing member is used to pierce or cut through any coating on the exterior of the metal structure the clamp assembly is attached to. The bonding member is attached, coupled or secured, either removably or permanently, to the main body via one or more coupling members. The one or more coupling members include one or more channels or slots located through the main body and one or more pairs of arms that extend from the bonding member. The one or more pairs of arms are inserted through the slots and at least a portion of the arms are folded in such a way that prevents the arms from being pulled back through the slots to removably or permanently attach, couple or otherwise secure the bonding member to the main body.

In another exemplary embodiment, the clamp assembly includes a main body and a clamping member. The main body includes a ground element connector and at least one piercing member. The ground element connector may be, for example a bore, configured to receive at least a portion of one or more grounding elements. The at least one piercing member extends away from the main body and is used to pierce or cut through any protective coating on the exterior of the metal structure the clamp assembly is attached to. The clamping member is configured to receive at least a portion of the metal structure to which the clamp assembly is attached and couples the base and the main body together and to the metal structure. The positions of the main body and clamping member relative to one another are adjustable to permit the clamp assembly to receive different sizes of structures.

In another exemplary embodiment, the clamp assembly includes a base, a main body and at least one clamping member. The main body has a structure contacting surface that includes at least one piercing member. The at least one piercing member may include a plurality of piercing members or a single piercing member, such as a tooth. The at least one piercing member may have a serrated distal end. In other embodiments, the at least one piercing member may include a raised surface having an aperture therethrough. The at least one piercing member may be integrally or monolithically formed from the main body. The base may include a first conductor gripping member and the main body may include a second conductor gripping member that aligns with the first conductor gripping member such that a channel configured to receive one or more grounding elements is formed. The at least one clamping member is configured to clamp the one or more grounding elements between the base and main body and to clamp the base and main body to the metal structure when the at least one clamping member is tightened.

In another exemplary embodiment, the clamp assembly includes a base, a main body, a bonding member and at least one clamping member. The base may include a first conductor gripping member and the main body may include a second conductor gripping member that aligns with the first conductor gripping member such that a channel configured to receive one or more grounding elements is formed. The bonding member is coupled with the main body and includes at least one piercing member extending therefrom. The at least one piercing member may include a plurality of piercing members or a single piercing member, such as a tooth. The at least one piercing member may have a serrated distal end. In other embodiments, the at least one piercing member may include a raised surface having an aperture therethrough. The at least one piercing member may be integrally or monolithically formed from the main body. The at least one clamping member is configured to clamp the one or more grounding elements between the base and the main body and to clamp the base, main body and bonding member to the metal structure when the at least one clamping member is tightened.

In another exemplary embodiment, the clamp assembly includes a main body and at least one clamping member. The main body includes a grounding element connector and at least one piercing member. The grounding element connector is configured to receive one or more grounding elements and to secure the one or more grounding elements to the main body. The at least one piercing member is configured to pierce a coating on the metal structure. The at least one piercing member may include a plurality of piercing members or a single piercing member, such as a tooth. The at least one piercing member may have a serrated distal end. In other embodiments, the at least one piercing member may include a raised surface having an aperture therethrough. The at least one piercing member may be integrally or monolithically formed from the main body. The at least one clamping member is configured to clamp the main body to the metal structure when the at least one clamping member is tightened.

### BRIEF DESCRIPTION OF THE DRAWINGS

To further clarify the above and other advantages and features of the subject matter of this patent specification, specific examples of embodiments thereof are illustrated in the appended drawings. It should be appreciated that these drawings depict only illustrative embodiments and are therefore not to be considered limiting of the scope of this patent specification or the appended claims. The subject matter hereof will be described and explained with additional specificity and detail through the accompanying drawings in which:

FIG. 1 is a perspective view of an exemplary embodiment of an electrical clamp assembly according to the present disclosure, illustrating a base member, a main body having one or more piercing members and a clamping member used to secure the base member and main body to a metal structure;

FIG. 2 is an exploded perspective view of the electrical clamp assembly of FIG. 1;

FIG. 3 is an exploded perspective view of another exemplary embodiment of an electrical clamp assembly according to the present disclosure, illustrating a base member, a main body having one or more piercing members, a secondary body and another exemplary embodiment of clamping member used to secure the base member, the main body and the secondary body to a metal structure;

FIG. 4 is an enlarged partial cross-sectional view of a portion of the electrical clamp assembly of FIG. 1 taken from detail 4, and illustrating the one or more piercing members;

FIG. 5 is a side elevation view of a portion of the electrical clamp assembly similar to FIG. 4, illustrating the base member separated from the main body;

FIG. 6 is a cross-sectional view of a portion of the electrical clamp assembly of FIG. 4 taken along line 6-6, and illustrating an exemplary embodiment of a piercing member used to pierce coatings on metal structures;

FIG. 7 is a cross-sectional view of a electrical clamp assembly similar to FIG. 6, illustrating a serrated distal end of the piercing member;

FIG. 8 is a side perspective view of the electrical clamp assembly of FIG. 1 being attached to a metal structure in partial cross-section, and illustrating the plurality of piercing members positioned to pierce through any coating on the exterior the metal structure when the electrical clamp assembly is secured to the metal structure;

FIG. 9 is an enlarged view of a portion of the electrical clamp assembly and metal structure of FIG. 8 taken from detail 9, illustrating the piercing members piercing through any coating on the exterior of the metal structure;

FIG. 10 is a cross-sectional view of a portion of the electrical clamp and metal structure of FIG. 9 taken along line 10-10, illustrating a piercing member piercing any coating on the exterior of the metal structure;

FIG. 11 is a perspective view of another exemplary embodiment of a main body of the electrical clamp assembly according to the present disclosure, illustrating another exemplary embodiment of a bonding member according to the present disclosure being attached to the main body;

FIG. 12 is a side perspective view of a portion of the main body of FIG. 11, illustrating the bonding member attached to the main body;

FIG. 13 is a side elevation view of the main body of FIG. 12, illustrating the bonding member attached to the main body;

FIG. 14 is a side perspective view of another exemplary embodiment of a bonding member of the electrical clamp assembly according to the present disclosure;

FIG. 15 is a perspective view of another exemplary embodiment of a bonding member of the electrical clamp according to the present disclosure;

FIG. 16 is a perspective view of another exemplary embodiment of a bonding member of the electrical clamp according to the present disclosure;

FIG. 17 is a side perspective view of the electrical clamp assembly of FIG. 1 with the main body and bonding member of FIG. 11 being attached to a metal structure, and illustrating a plurality of piercing members extending from the bonding member positioned to pierce through any coating on the exterior the metal structure when the electrical clamp assembly is secured to the metal structure;

FIG. 18 is an enlarged perspective view of a portion of the electrical clamp and metal structure of FIG. 17 taken from detail 18, illustrating piercing members of the bonding member piercing through any coating on the exterior the metal structure;

FIG. 19 is a cross-sectional view of a portion of the electrical clamp and metal structure of FIG. 18 taken along line 19-19, illustrating a piercing member piercing any coating on the exterior of the metal structure;

FIG. 20 is a perspective view of another exemplary embodiment of a main body of the electrical clamp assembly of FIG. 1, illustrating another exemplary embodiment of a bonding member according to the present disclosure being attached to the main body;

FIG. 21 is a side elevation view of the electrical clamp of FIG. 20, illustrating the bonding member attached to the main body;

FIG. 22 is a side perspective view of the electrical clamp assembly of FIG. 1 with the main body and bonding member of FIG. 20 being attached to a metal structure, illustrating the bonding member attached to the main body and a plurality of piercing members extending from the bonding member of the electrical clamp and positioned to pierce through any coating on the exterior the metal structure when the electrical clamp assembly is secured to the metal structure;

FIG. 23 is an enlarged view of a portion of the electrical clamp and metal structure of FIG. 22 taken from detail 23, illustrating the piercing members of the bonding member piercing through any coating on the exterior the metal structure;

FIG. 24 is a cross-sectional view of a portion of the electrical clamp and metal structure of FIG. 23 taken along line 24-24, illustrating a piercing member of the bonding member piercing any coating on the exterior of the metal structure;

FIG. 25 is a perspective view of another exemplary embodiment of a main body of an electrical clamp assembly according to the present disclosure, illustrating a bonding member being attached to the main body;

FIG. 26 is a perspective view of the electrical clamp assembly of FIG. 25, illustrating the bonding member attached to the main body;

FIG. 27 is a side perspective view of the electrical clamp assembly of FIG. 1 with the main body and bonding member of FIG. 26 being attached to a metal structure, and illustrating a plurality of piercing members extending from the bonding member and positioned to pierce through any coating on the exterior the metal structure when the electrical clamp assembly is secured to the metal structure;

FIG. 28 is an enlarged view of a portion of the electrical clamp assembly and metal structure of FIG. 27 taken from detail 28, illustrating the piercing members of the bonding member piercing through any coating on the exterior of the metal structure;

FIG. 29 is a cross-sectional view of a portion of the electrical clamp and metal structure of FIG. 28 taken along line 29-29, illustrating a piercing member piercing any coating on the exterior of the metal structure;

FIG. 30 is a perspective view of another exemplary embodiment of a main body of an electrical clamp assembly according to the present disclosure, illustrating another exemplary embodiment of a bonding member according to the present disclosure being attached to the main body;

FIG. 31 is a perspective view of the electrical clamp assembly of FIG. 30, illustrating the bonding member attached to the main body;

FIG. 32 is a side perspective view of the electrical clamp assembly of FIG. 1 with the main body and bonding member of FIG. 30 being attached to a metal structure, and illustrating a plurality of piercing members extending from the bonding member and positioned to pierce through any coating on the exterior of the metal structure when the electrical clamp assembly is secured to the metal structure;

FIG. 33 is an enlarged view of a portion of the electrical clamp assembly and metal structure of FIG. 32 taken from detail 33, illustrating the piercing members of the bonding member piercing through any coating on the exterior of the metal structure;

FIG. 34 is a cross-sectional view of a portion of the electrical clamp assembly and metal structure of FIG. 33 taken along line 34-34, illustrating a piercing member piercing any coating on the exterior of the metal structure;

FIG. 35 is a perspective view of another exemplary embodiment of a main body of an electrical clamp assembly according to the present disclosure, illustrating another exemplary embodiment of a bonding member according to the present disclosure being attached to the main body;

FIG. 36 is a perspective view of the electrical clamp assembly of FIG. 35, illustrating the bonding member being attached to the main body;

FIG. 37 is a side perspective view of the electrical clamp assembly of FIG. 1 with the main body and bonding member of FIG. 35, illustrating a plurality of piercing members extending from the bonding member and positioned to pierce through any coating on the exterior of the metal structure when the electrical clamp assembly is secured to the metal structure;

FIG. 38 is an enlarged view of a portion of the electrical clamp assembly and metal structure of FIG. 37 taken from detail 38, illustrating the piercing members of the bonding member piercing through any coating on the exterior of the metal structure;

FIG. 39 is a cross-sectional view of a portion of the electrical clamp assembly and metal structure of FIG. 38 taken along line 39-39, illustrating a piercing member piercing any coating on the exterior of the metal structure;

FIG. 40 is a perspective view of another exemplary embodiment of an electrical clamp assembly according to the present disclosure, illustrating a body having one or more piercing members extending from the body and a clamping member used to secure the electrical clamp assembly to the metal structure;

FIG. 41 is an exploded view of the electrical clamp assembly of FIG. 40;

FIG. 42 is a side perspective view of the electrical clamp assembly of FIG. 40 being attached to a metal structure, and illustrating the one or more piercing members extending from the main body and positioned to pierce through any coating on the exterior of the metal structure when the electrical clamp assembly is secured to the metal structure;

FIG. 43 is an enlarged view of a portion of the electrical clamp assembly and metal structure of FIG. 42 taken from detail 43, illustrating the piercing members of the bonding member piercing through any coating on the exterior of the metal structure; and

FIG. 44 is a cross-sectional view of a portion of the electrical clamp assembly and metal structure of FIG. 43 taken along line 44-44, illustrating a piercing member piercing any coating on the exterior of the metal structure.

### DETAILED DESCRIPTION

The present disclosure provides descriptions of embodiments for electrical clamp assemblies having one or more bonding structures used to electrically bond the electrical clamp assemblies to metal structures coated with an environmentally protective material that may not be electrically conductive. When the electrical clamp assemblies according to the present disclosure are electrically connected to electrical ground, the one or more bonding structures provide an electrically conductive path from the metal structure through the electrical clamp assembly to the electrical ground. The electrical clamp assemblies can be electrically connected to electrical ground using, for example, ground conductors that are connected to grounding systems that may include one or more ground rods inserted into the earth or carbon black mats buried in the earth or soil. The metal structures contemplated by the present disclosure include, but are not limited to, posts, e.g., fence posts, helical pile shafts, rods, tubes, and pipes. The metal structures may be, for example, round, square, hexagonal or pentagonal structures, or H-beam or I-beam like structures, or any other type of structures that may need to be electrically bonded. For case of description, the metal structures may also be referred to herein as the “structures” in the plural and the “structure” in the singular. The environmentally protective and/or non-conductive materials that may be coated on the metal structures contemplated by the present disclosure may not be able to conduct electricity and include, but are not limited to, oxides, paints, anodization, powder coatings, epoxies and enamels. For case of description, the environmentally protective and/or non-conductive materials coating the structures may also be referred to herein as the “coatings” in the plural and the “coating” in the singular. The electrical clamp assemblies described herein and contemplated by the present disclosure may also be referred to herein as the “clamps” or “clamp assemblies” in the plural and the “clamp” or “clamp assembly” in the singular.

While several embodiments are described, the subject matter described in this patent disclosure is not limited to any one embodiment or combination of embodiments described herein, but instead encompasses numerous alternatives, modifications, and equivalents. In addition, while numerous specific details are set forth in the following description to provide a thorough understanding, some embodiments can be practiced without some or all such details. Moreover, for the purpose of clarity, certain technical material that is known in the related art has not been described in detail in order to avoid unnecessarily obscuring the new subject matter described herein. It should be clear that individual features of one or several of the specific embodiments described herein can be used in combination with features of other described embodiments or with other features. Further, like reference numbers and designations in the various drawings indicate like elements.

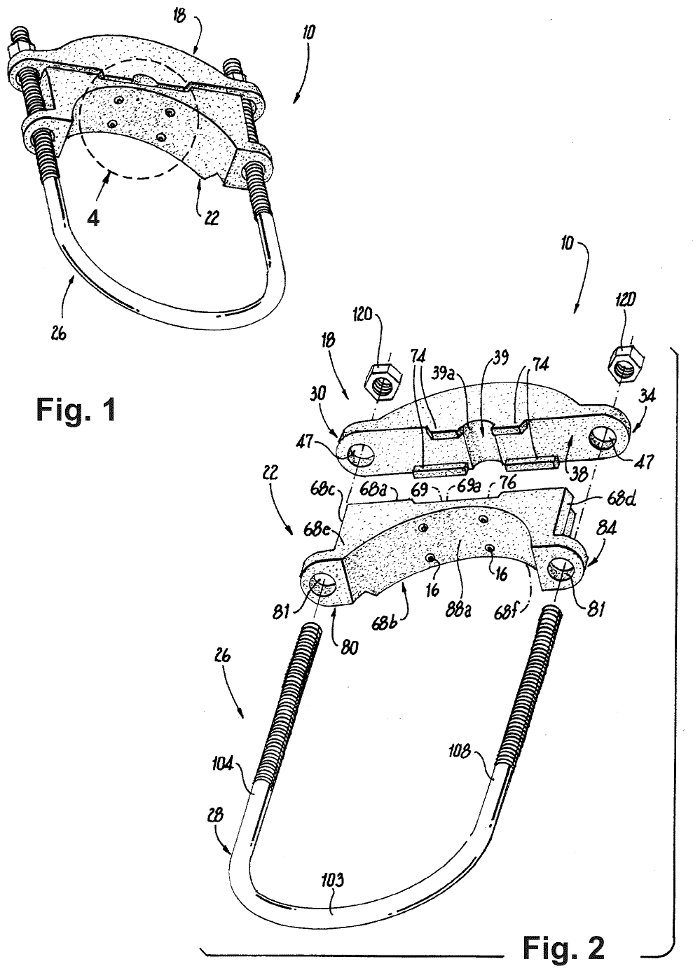

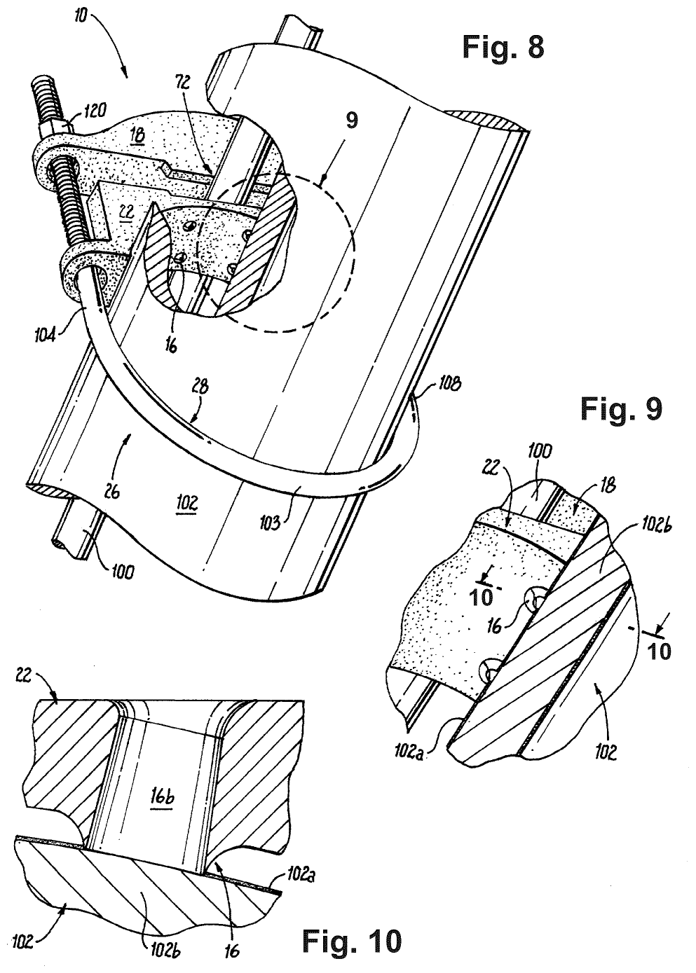

Referring to FIGS. 1, 2 and 4-10, an exemplary embodiment of a clamp assembly according to the present disclosure is shown. In this exemplary embodiment, the clamp assembly 10 includes a base 18, a main clamp body 22 and one or more clamping members 26. As shown in FIGS. 1-2, base 18 includes a first end 30, a second end 34 opposite the first end 30 and a side 38 that extends between the first end 30 and the second end 34. For case of description, the main clamp body 22 may also be referred to herein as the “main body.” In some embodiments, the side 38 includes a conductor gripping member 39 in facing relationship with the main body 22. In some embodiments, the conductor gripping member 39 may be configured and dimensioned as a recess, notch, cut, groove, channel or other structure, member or indent in the side 38 of the base 18. In some embodiments, the conductor gripping member 39 may be configured and dimensioned as a tab, rib, bulge, projection or other protrusion extending from the side 38. The conductor gripping member 39 includes a contact surface 39a, as shown in FIG. 5. In this embodiment, the contact surface 39a is a semi-circular groove. However, the present disclosure contemplates other shapes for the contact surface 39a. Contact surface 39a may include a grip enhancing feature, such as for example, teeth, ridges or knurling that allows the conductor gripping member 39 to better grip one or more grounding elements 100, seen in FIG. 8. In the embodiments shown herein, there is a single grounding element 100. However, the present disclosure contemplates that the clamp assemblies 10 described herein can be configured to receive a single grounding element 100 or more than one grounding element 100. Non-limiting examples of the grounding elements 100 include electrically conductive cables, conductors, ribbons, wires or rods. For case of description, the grounding element 100 may also be referenced herein as the “conductor,” the “wire,” the “cable” and/or the “rod.” The side 38 of the base 18 may also include one or more rails 74, e.g., tabs, shown in FIGS. 2 and 5, that are used to assist in the alignment of base 18 with main body 22 when attaching the clamp assembly 10 to a structure 102, shown in FIG. 8. Non-limiting examples of structures 102 contemplated by the present disclosure include helical pile shafts, poles, e.g., fence poles, pipes, rods, tubes and posts. The first and second ends 30 and 34 include respective apertures, bores or openings 47 extending therethrough. In some embodiments, the base 18 is formed from electrically conductive materials. Non-limiting examples of electrically conductive materials include copper, aluminum, aluminum alloys, brass and brass alloys. In the embodiment shown, the base 18 is preferably formed from a brass alloy.

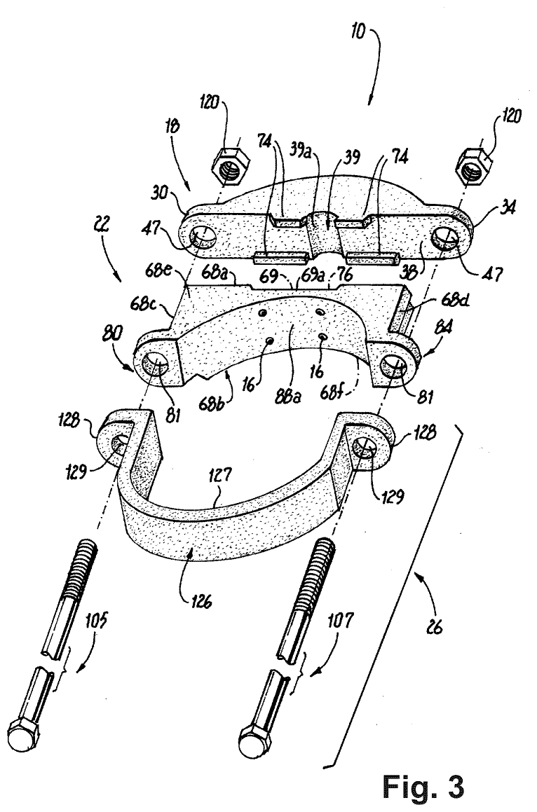

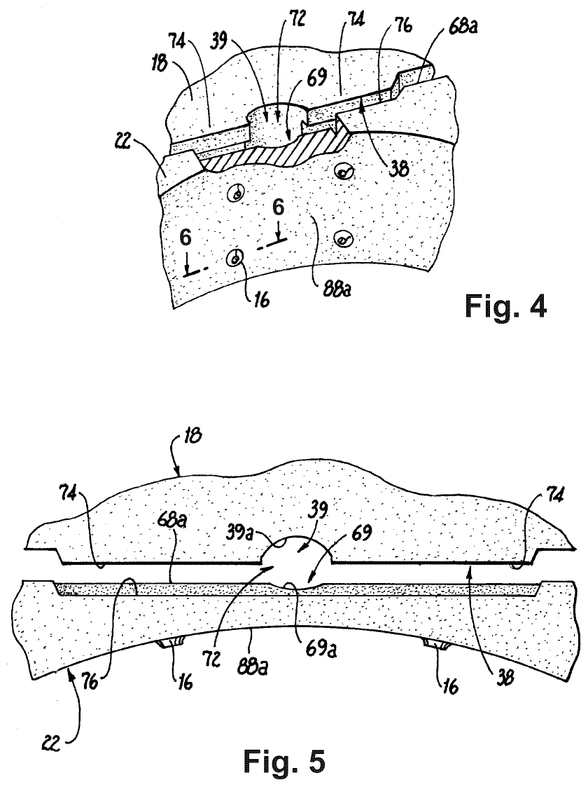

Continuing to refer to FIGS. 1-10, the main body 22 includes a first wall 68a, a second wall 68b opposite the first wall 68a, a third wall 68c, a fourth wall 68d opposite the third wall 68c, and two sides 68e and 68f that connect the walls 68a-68d. The first wall 68a is in a facing relationship with side 38 of base 18. In some embodiments, the first wall 68a includes a conductor gripping member 69, seen in FIG. 4, positioned on the first wall 68a so that the conductor gripping member 69 corresponds to the conductor gripping member 39 positioned on the side 38 of the base 18. In some embodiments, the conductor gripping member 69 may be configured and dimensioned as a recess, notch, cut, groove, channel or other structure, member or indent in the first wall 68a. In some embodiments, the conductor gripping member 69 may be configured and dimensioned as a tab, rib, bulge, projection or other protrusion extending from the first wall 68a. The conductor gripping member 69 includes a contact surface 69a. In some embodiments, the contact surface 69a is a semi-circular groove. However, the present disclosure contemplates other shapes for the contact surface 69a. The contact surface 69a may include a grip enhancing feature, such as for example, teeth, ridges or knurling that allow contact surface 69a to better grip the one or more grounding elements 100, seen in FIG. 8. In this configuration, when attaching the clamp assembly 10 to a structure, such as a post or pole, the conductor gripping member 39 of the base 18 and the conductor gripping member 69 of the main body 22 oppose each other to form a conductor channel 72, seen in FIGS. 4 and 5. The first wall 68a of the main body 22 may also include one or more tracks 76 configured and dimensioned to receive the one or more rails 74 of base 18 to assist in the alignment of the main body 22 with the base 18 when attaching the clamp assembly 10 to a structure, as shown in FIG. 5. In some embodiments, the main body 22 may also include a first end projection 80 that extends from the third wall 68c and a second end projection 84 that extends from the fourth wall 68d, seen in FIGS. 2 and 3. The first and second end projections 80 and 84 include apertures 81 positioned to align with apertures 47 of base 18. In some embodiments, main body 22 is formed from electrically conductive materials. Non-limiting examples of electrically conductive materials include copper, aluminum, aluminum alloys, brass and brass alloys. In the embodiment shown, the main body 22 is preferably formed from a brass alloy.

The second wall 68b of the main body 22 includes a structure contacting surface 88a. The structure contacting surface 88a is configured and dimensioned to receive at least a portion of the structure 102 the clamp assembly 10 is to be attached. In some embodiments, the structure contacting surface 88a is arcuate in shape. However, the present disclosure contemplates other shapes for the structure contacting surface 88a. The structure contacting surface 88a includes one or more piercing members 16 used to pierce or cut through any coating on the exterior of the structure 102. In the embodiment shown in FIGS. 1 and 2, the structure contacting surface 88a has four piercing members 16 positioned on a central portion of the second wall 68b of the main body 22. It is contemplated within this disclosure that there may be more or fewer piercing members 16 located at any location on the contact surface 88a.

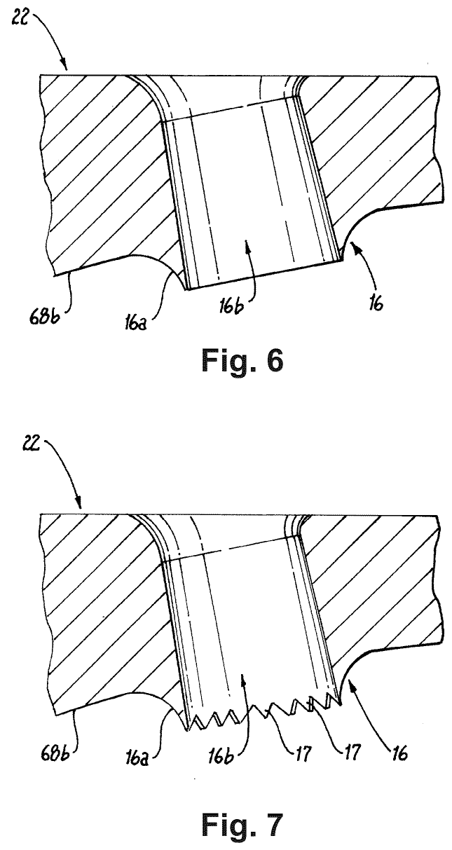

Referring to FIGS. 6-7, each piercing member 16 is preferably capable of cutting through or piercing any coatings on an exterior of a structure 102, seen in FIG. 8, that the clamp assembly 10 is to be attached. In some embodiments, each piercing member 16 may form a tooth-like structure, or each piercing member 16 may form what is sometimes called in the industry a “volcano.” For example, the piercing member 16 can be a raised surface 16a extending from the second wall 68b forming a tooth-like structure. The raised surface 16a may include an aperture 16b therethrough forming a volcano-like structure with a sharp edge at the distal end of the raised surface 16a enabling each piercing member 16 to cut through or pierce coatings on the structure 102. Each piercing member 16 can be a unitary circular member, a curve or arcuate shaped member or other shaped member or structure. In the exemplary embodiment shown in FIG. 6, each piercing member 16 is a unitary circular member that is capable of cutting through or piercing any coating on structure 102. In some embodiments, each piercing member 16 can be a unitary circular or other shaped member or structure having a serrated distal edge 17, shown in FIG. 7, that is also capable of cutting through or piercing the coatings on the structure 102.

In the exemplary embodiment of FIGS. 1-10, each of the one or more piercing members 16 may be integrally or monolithically formed into the main body 22. In another exemplary embodiment, each of the one or more piercing members 16 may be secured to the main body 22 by, for example, a welded joint. As noted, in this exemplary embodiment, the one or more piercing members 16 are disposed on a central portion of the second wall 68b and extend from the structure contacting surface 88a of the main body 22. However, the one or more piercing members 16 may be disposed, placed or arranged on the second wall 68b of the main body 22 in any location suitable to cut through or pierce coatings on the structure 102, and establish and maintain an electrically conductive path between the one or more piercing members 16 and the metal of the structure 102. While the above-described embodiment shows more than one piercing member 16 used to cut through or pierce the any coating on the outer surface of the structure 102 to which the clamp assembly 10 is attached, the present disclosure contemplates that a single piercing member 16 may be positioned on the second wall 68b to cut through or pierce any coating 102a on the structure 102.

Referring now to FIGS. 1-3, the one or more clamping members 26 are configured and dimensioned to secure the base 18 and/or main body 22 to the structure 102. In the exemplary embodiment shown in FIGS. 1 and 2, the one or more clamping members 26 is a single clamping member formed by a clamp body 28, e.g., a threaded U-bolt, and a pair of fastening elements 120, e.g., nuts. The clamp body 28 includes a main portion 103 and two leg portions 104 and 108 extending from the main portion 103. The clamp body 28 is configured and dimensioned to receive the structure 102, seen in FIG. 8, so that the structure 102 can rest at least partially in the main portion 103. With the structure 102 at least partially within the main portion 103, the two leg portions 104 and 108 of the clamp body 28 can pass through respective apertures 81 of the main body 22 and through respective apertures 47 of the base 18 when securing the clamp assembly 10 to the structure 102. The fastening elements 120, for example, hex nuts, are then threaded onto the threaded leg portions 104 and 108 and tightened to removably or permanently attach, couple or otherwise secure the base 18, main body 22, one or more grounding elements 100 and the clamping member 26 to the structure 102.

In the exemplary embodiment of FIG. 3, the clamping member 26 includes a clamp body 126 and one or more fastener assemblies that include fastening elements 105 and 107, e.g., threaded bolts, and corresponding fastening elements 120, e.g., nuts. The clamp body 126 includes a main portion 127 and two projections 128 extending from the main portion 127. The main portion 127 is configured and dimensioned to receive at least a portion of the structure 102 to which the clamp assembly 10 is to be attached. The main portion 127 may be, for example, at least partially arcuate in shape, semi-circular in shape, square in shape, rectangular in shape or any other shape suitable to fit around or receive at least a portion of the structure 102 to which the clamp assembly 10 is to be attached. Each projection 128 includes an aperture 129 extending therethrough configured to receive a respective fastening element 105 or 107. With the structure 102 at least partially within the main portion 127, the two fastening elements 105 and 107 are passed through a respective aperture 129 in the clamp body 126, through the respective aperture 81 in the main body 22 and through the respective aperture 47 in the base 18. The fastening elements 120, for example, hex nuts, are then threaded onto the threaded portions of the fastening elements 105 and 107 and tightened to secure the main body 22, the clamp body 126, the base 18, the one or more grounding elements 100 and the clamping members 26 to the structure 102. In this exemplary embodiment, the structure 102 is clamped between the main body 22 and the clamp body 126. The one or more clamping members 26 may be formed from a metallic material, such as stainless steel, galvanized steel or zinc.

Referring to FIGS. 8-10, an exemplary embodiment for attaching the clamp assembly 10 of FIG. 1 to one or more grounding elements 100 and a metal structure 102 is described. Initially, the base 18 and the main body 22 are removed from the clamping member 26, and the clamping member is positioned around the metal structure 102 as shown in FIG. 8. The main body 22 is then inserted onto the ends of the leg portions 104 and 108 of the clamping member 26, and the one or more grounding elements 100 are positioned in proximity to the conductor gripping member 69 of the first wall 68a of the main body 22. The base 18 is then inserted onto the ends of the leg portions 104 and 108, and fastening elements 120 are tightened to draw the base 18, the main body 22 and the one or more grounding elements 100 toward the metal structure 102. In this exemplary embodiment, the base 18 may be adjusted relative to the main body 22 to permit the clamp assembly 10 to receive different size grounding elements 100. To illustrate, for the embodiment of FIGS. 1 and 2, a position of the base 18 relative to the main body 22 may be adjusted by moving, e.g., by sliding the base 18 along the two leg portions 104 and 108 toward or away from the main body 22. As another illustration, for the embodiment of FIG. 3, a position of the base 18 relative to the main body 22 may be adjusted by moving, e.g., by sliding the base 18 along the fastening elements 105 and 107 of the clamping member 26 toward or away from the main body 22. As an exemplary result, sliding the base 18 away from the main body 22 increases one or more dimensions of the conductor channel 72, seen in FIG. 5, to permit larger size grounding elements 100 to be received by the conductor channel 72. Conversely, sliding the base 18 toward the main body 22 decreases one or more dimensions of the conductor channel 72 so that smaller size grounding elements 100 can be received by the conductor channel 72. In addition, the fastening elements 120 move the base 18 toward and possibly against the main body 22 attaching, clamping or otherwise securing or clamping the one or more grounding elements 100 within the conductor channel 72 between the base 18 and main body 22.

The main body 22 may also be adjustable relative to the metal structure 102 positioned within the clamp assembly 10 by moving the main body 22 along the respective clamping member or clamping members. To illustrate, for the exemplary embodiment of FIGS. 1 and 2, the main body 22 may be adjusted to change a distance between the main portion 103 of the clamping member 26, e.g., a U-bolt type clamping member, and the structure contacting surface 88a of the main body 22. Sliding the main body 22 on the leg portions 104 and 108 of the clamping member 26 away from the main portion 103 of the clamping member increases the distance between the main portion 103 and the structure contacting surface 88a of the main body 22. Conversely, sliding the main body 22 on the leg portions 104 and 108 of the clamping member 26 toward the main portion 103 of the clamping member 26 decreases the distance between the main portion 103 and the structure contacting surface 88a of the main body 22. As such, the clamp assembly 10 is adjustable to receive different sizes of grounding elements 100 and structures 102 by changing the relative positions of the base 18, the main body 22 and the clamping member 26. To illustrate, for the exemplary embodiment of FIG. 3, the main body 22 may be adjusted to change the distance between the clamp body 126 and the structure contacting surface 88a of the main body 22. Sliding the main body 22 on the fastening elements 105 and 107 away from the clamp body 126 increases the distance between the clamp body 126 and the structure contacting surface 88a of the main body 22. Conversely, sliding the main body 22 on the fastening elements 105 and 107 toward the clamp body 126 decreases the distance between the clamp body 126 and the structure contacting surface 88a of the main body 22. As such, the clamp assembly 10 is adjustable to receive different sizes of grounding elements 100 and structures 102 by changing the relative positions of the base 18, the main body 22 and the clamp body 126.

Continuing to refer to FIGS. 8-10, with the clamp assembly 10 and one or more grounding elements 100 positioned on the metal structure 102, the fastening elements 120 are tightened to move or draw the base 18 and one or more grounding elements 100 toward the main body 22, and move or draw the base 18, one or more grounding elements 100 and main body 22 toward the structure 102 to establish an electrically conductive path therebetween. In this exemplary embodiment, structure 102 is a round helical pile shaft and the one or more grounding elements 100 are electrically conductive wires. It is noted that the electrically conductive wire may be in different sizes. As a non-limiting example, the size of the electrically conductive wire may range from about #6 AWG to about 500 kcmil. As the fastening elements 120 are tightened, the force, e.g., the compression force, applied by the one or more clamping members 26 on the base 18, the main body 22 and the structure 102 increases causing the one or more piercing members 16 extending from the main body 22 to contact the exterior of the structure 102. As the force is further increased, the one or more piercing members 16 pierce or cut through any coating on the exterior of the structure 102 creating an electrically conductive path between the structure 102 and the main body 22 so that an electrically conductive path is established between the one or more grounding elements 100 and the structure 102.

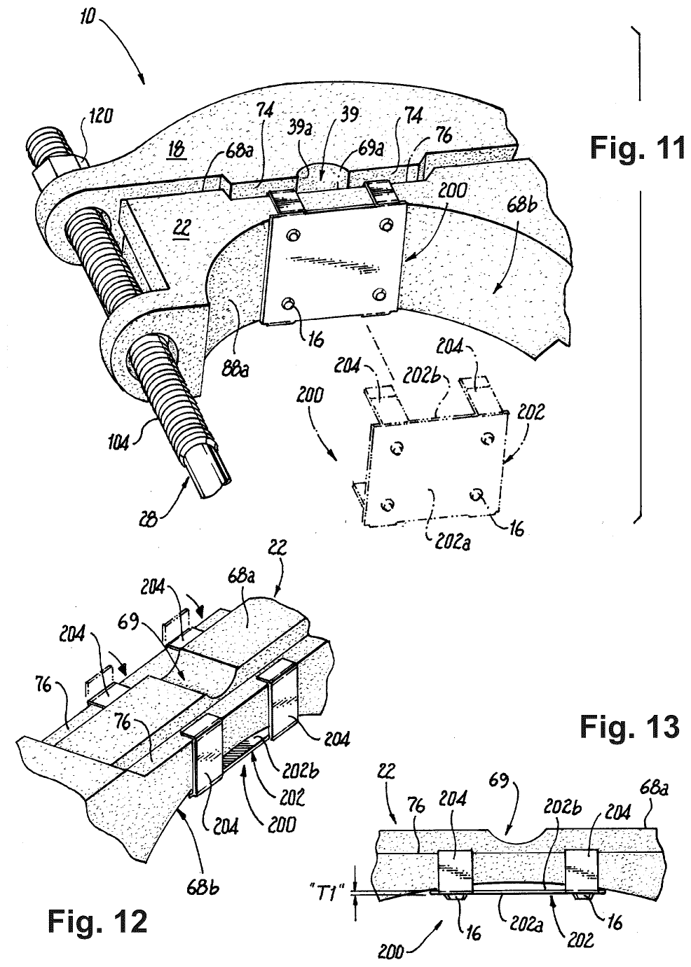

Referring to FIGS. 11-19, additional exemplary embodiments of a clamp assembly according to the present disclosure are shown. In these exemplary embodiments, the clamp assembly 10 is substantially the same as the clamp assembly described above, except that the piercing members 16 are not included on the main body 22. Instead, the clamp assembly 10 includes one or more bonding members 200 that are attached to the main body 22. More specifically, the one or more bonding members 200 are attached to the main body 22 so that when the clamp assembly 10 is attached to a structure 102, the one or more piercing members 16 extending from the one or more bonding members 200 can cut through or pierce coatings on an outer surface of the structure 102.

Referring now to FIGS. 11-13, an exemplary embodiment of a bonding member 200 is shown. The bonding member 200 includes an electrically conductive body 202, one or more piercing members 16, and one or more coupling members 204. The body 202 can be of any shape and/or size, but is preferably configured and dimensioned to contact the structure contacting surface 88a of the second wall 68b of the main body 22. The body 202 has a top surface 202a and a bottom surface 202b. The body 202 may be substantially flat and sufficiently flexible to conform to the shape of structure contacting surface 88a and/or the exterior of the structure 102 when force is applied on the bonding member 200 by the structure 102 when securing the clamp assembly 10 to the structure 102. The one or more piercing members 16 can be the same as the piercing members 16 shown on the main body 22 of the clamp assembly 10, described above and shown in FIGS. 6 and 7. The one or more piercing members 16 may be integral with or monolithically formed into the body 202, or the one or more piercing members 16 may be secured to the body 202 by, for example, welding the piercing members 16 to the body 202. The one or more piercing members 16 may extend from the top surface 202a or the bottom surface 202b of the body 202. In this exemplary embodiment, the one or more piercing members 16 extend from the top surface 202a of the body 202 so that the at least one piercing member 16 can cut through or pierce any coating on the structure 102 when attaching the clamp assembly 10 to the structure 102. In the embodiment shown in FIGS. 11-13, there are four piercing members 16 extending from the top surface 202a of the body 202.

Continuing to refer to FIGS. 11-13, the one or more coupling members 204 are provided to removably or permanently attach, couple or otherwise secure the bonding member 200 to the main body 22 of the clamp assembly 10. The one or more coupling members 204 extend from the body 202 in a direction away from the surface of the body 202 from which the one or more piercing members 16 extend from. In this exemplary embodiment, the one or more coupling members 204 extend away from the bottom surface 202b of the body 202, as shown FIG. 11. In the embodiment shown in FIGS. 11-13, the coupling members 204 are arms that are monolithically formed into the body 202 and then bent to extend from the body 202 in a direction away from the bottom surface 202b. However, the arms 204 may be integral with the body 202, or the arms may be secured to the body 202 by, for example, welding the arms to the body. In the embodiments shown, there are four arms 204 extending from the body 202 at a point in close proximity to the corners of the body 202. However, one skilled in the art would readily appreciate that any number of arms 204 may be used along any portion of the body 202 so long as the body 202 of the bonding member 200 can be removably or permanently attached, coupled or otherwise secured to the main body 22 with the bottom surface 202b of the body 202 facing the contact surface 88a of main body 22. The arms 204 may have a length “L,” seen in FIG. 16, which is the length that the arms extend away from the body 202. The length “L” should be sufficiently long to allow at least a portion of the arms 204 to be folded such that the folded portion of the arms are in contact with the first side 68a of the main body 22 to removably or permanently attach, couple or otherwise secure the bonding member 200 to the main body 22.

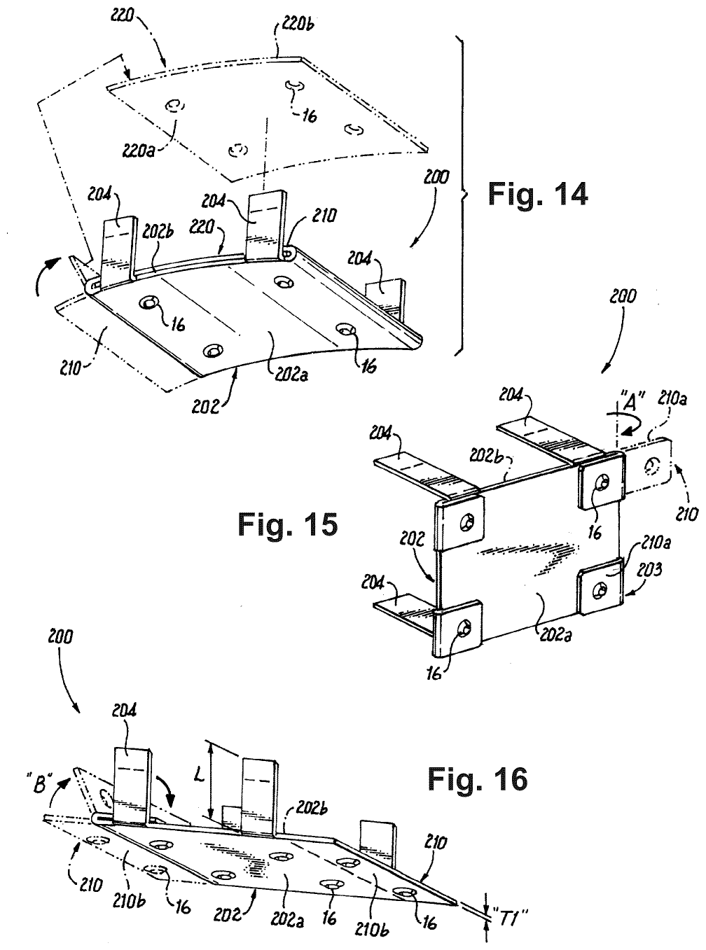

In another exemplary embodiment shown in FIG. 14, the body 202 of the bonding member 200 may be shaped to match the shape of the structure contacting surface 88a of the main body 22. For example, in the embodiment of the main body 22 of FIG. 11 and the bonding member 200 of FIG. 14, the structure contacting surface 88a of the main body 22 has an arcuate shape and the shape of the body 202 of the bonding member 200 conforms to the arcuate shape of the structure contacting surface 88a. The body 202 is made of an electrically conductive material that provides sufficient structural rigidity to establish and maintain an electrically conductive path between the structure 102 and the bonding member 200. Non-limiting examples of the electrically conductive materials for the body 202 include stainless steel, brass, brass alloys, aluminum and/or aluminum alloy. The body 202 of the bonding member 200 may also have a predetermined thickness “T1” seen in FIG. 13, which can vary for different size bonding members 200. The predetermined thickness “T1” may depend on a number of factors, including, for example, the thickness of any coating on the structure 102 and the anticipated or rated current the bonding member 200 forming the electrically conductive path is to carry. As a non-limiting example, the thickness “T1” may be in the range from about 0.125 mm to about 3.0 mm.

Continuing to refer to FIG. 14, the body 202 of the bonding member 200 may include one or more fold-over regions that form body extensions 210, and a second bonding member body 220 is positioned onto the bottom surface 202b of the body 202 so that a bottom surface 220a of the second bonding member body 220 rests on the bottom surface 202b of the body 202. The second bonding member body 220 may also be referred to herein as the “second body.” With second body 220 resting on the bottom surface 202b of the body 202, the body extensions 210 are folded over ends of the second body 220 to removably or permanently attach, couple or otherwise secure the second body 220 to the body 202. The second body 220 may include one or more piercing members 16 extending from a top surface 220b of the second body 220. The piercing members 16 of second body 220 are substantially similar to piercing members 16 seen on the body 202 described above. The piercing members 16 of the second body 220 may be oriented so that the piercing members 16 are positioned to enhance the electrically conductive path between the bonding member 200 and the main body 22 by, for example, piercing or otherwise cutting into the structure contacting surface 88a of the main body 22 and/or cutting through or piercing non-conductive material that may form on the structure contacting surface 88a of the main body 22. When the bottom surface 220a of the second body 220 is placed adjacent to the bottom surface 202b of the body 202, the body extensions 210 of the body 202 are folded over such that at least a portion of the body extensions 210 makes contact with the top surface 220b of the second body 220 thus removably or permanently attaching, coupling or otherwise securing or clamping the second body 220 to body 202.

In another exemplary embodiment shown in FIG. 15, the body 202 of the bonding member 200 may be flat similar to the embodiment of FIG. 11 or shaped to match the shape of the structure contacting surface 88a of the main body 22 similar to FIG. 14. The body 202 is made of an electrically conductive material that provides sufficient structural rigidity to establish and maintain an electrically conductive path between the structure 102 and the bonding member 200. Non-limiting examples of the electrically conductive materials for the body 202 include stainless steel, brass, brass alloys, aluminum and/or aluminum alloy. The body 202 of the bonding surface 200 may also have a predetermined thickness “T1,” seen in FIG. 13, which can vary for different size bonding members 200. The predetermined thickness “T1” may depend on a number of factors, including, for example, the thickness of any coating on the structure 102 and the anticipated or rated current the bonding member 200 forming the electrically conductive path is to carry. As a non-limiting example, the thickness “T1” may be in the range from about 0.125 mm to about 3.0 mm.

Continuing to refer to FIG. 15, the body 202 of the bonding member 200 may include one or more fold-over regions forming one or more body extensions 210. Each body extension 210 includes one or more piercing members 16 extending therefrom so that when the body extension 210 is folded in the direction of arrow “A”, the piercing members 16 are positioned to cut through or pierce any coating on the structure 102. More specifically, each of the one or more piercing members 16 extend from the top surface 210a of the body extension 210. When each body extension 210 is folded relative to the body 202, as shown by arrow “A” in FIG. 15, the one or more piercing members 16 extending from the top surface 210a of the body extension 210 are oriented so that the piercing members 16 are positioned to cut through or pierce any coating on the structure 102 when securing the clamp assembly 10 to the structure 102. The piercing members 16 of the body extensions 210 are the same as the piercing members 16 described herein.

In another exemplary embodiment shown in FIG. 16, the body 202 of the bonding member 200 is substantially similar to the embodiment of the body 202 of the bonding member 200 shown in FIG. 14, such that the body 202 may be flat similar to the embodiment of FIG. 11 or shaped to match the shape of the structure contacting surface 88a of the main body 22 similar to FIG. 14. The body 202 is made of an electrically conductive material that provides sufficient structural rigidity to establish and maintain an electrically conductive path between the structure 102 and the bonding member 200. Non-limiting examples of the electrically conductive materials for the body 202 include stainless steel, brass, brass alloys, aluminum and/or aluminum alloy. The body 202 of the bonding surface 200 may also have a predetermined thickness “T1,” seen in FIG. 13, which can vary for different size bonding members 200. The predetermined thickness “T1” may depend on a number of factors, including, for example, the thickness of any coating on the structure 102 and the anticipated or rated current the bonding member 200 forming the electrically conductive path is to carry. As a non-limiting example, the thickness “T1” may be in the range from about 0.125 mm to about 3.0 mm.

However, in this exemplary embodiment, the one or more body extensions 210 include piercing members 16 extending from the bottom surface 210b of the body extension 210 such that when the body extension 210 is folded relative to the body 202 in the direction of arrow “B” shown in FIG. 16, the piercing members 16 of the body extension 210 are oriented so that the piercing members 16 are positioned to enhance the electrically conductive path between the bonding member 200 and the main body 22 by, for example, piercing or otherwise cutting into the structure contacting surface 88a of the main body 22 and/or cutting through or piercing non-conductive material that may form on the structure contacting surface 88a of the main body 22.

In the embodiments of FIGS. 11-16, the bonding members 200 may also include one or more coupling members 204 provided to attach the bonding member 200 to the main body 22 of the clamp assembly 10. In the exemplary embodiments shown, the coupling members 204 may be arms that extend in a direction away from the bottom surface 202b of the body 202. The coupling members 204 may be integral with or monolithically formed into the body 202, or the coupling members 204 may be secured to the body 202 using, for example, welded joints or adhesives. In the embodiments shown, there is one coupling member 204 extending from the body 202 at or near the corners of the body 202. However, one skilled in the art would readily appreciate that any number of coupling members 204, e.g., arms, may be used along any portion of the body 202 so long as the body 202 of the bonding member 200 is removably or permanently secured to the main body 22 with the top surface 202a of the body 202 facing the contact surface 88a of main body 22. The coupling members 204 may have a length “L,” seen in FIG. 16, which is the length that the coupling members 204 extend away from the body 202. The coupling members 204 may be of any length “L” so long as the length “L” is sufficiently long to allow at least a portion of the coupling members 204 to be attached to the main body 22. For example, in the embodiment shown, the length “L” of the coupling members 204 is sufficiently long to allow the coupling members 204 to be folded such that the folded portion of the arms are in contact with and grip the first side 68a of the main body 22 so as to removably or permanently attach, couple or otherwise secure the bonding member 200 to the main body 22 as shown in FIGS. 11 and 12.

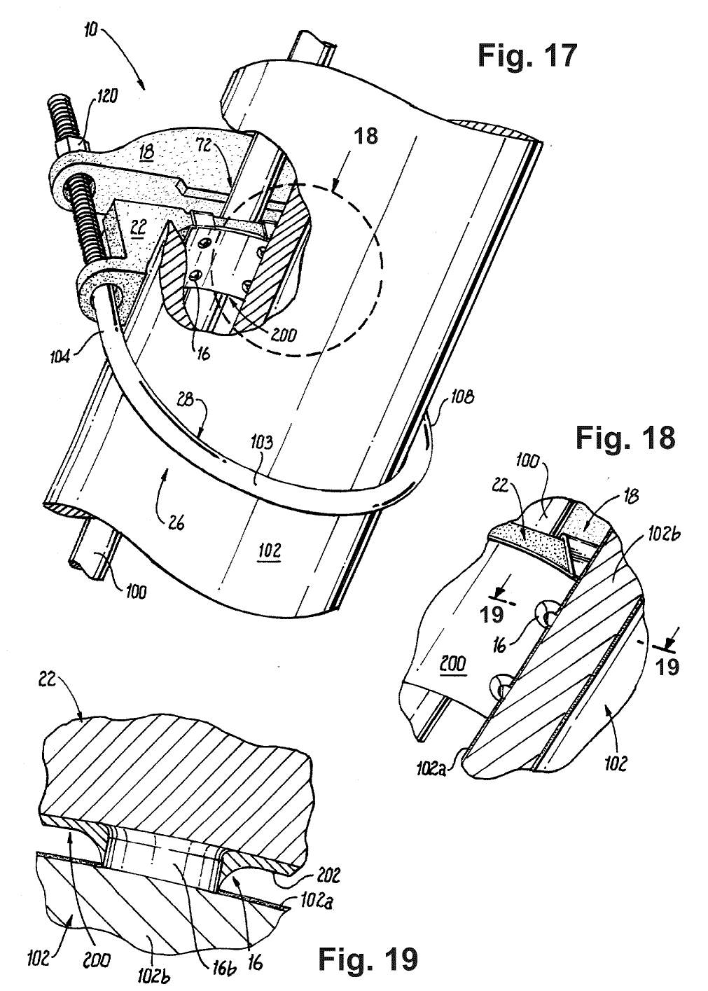

Referring to FIGS. 17-19, an exemplary embodiment for removably or permanently attaching, coupling or otherwise securing or clamping the clamp assembly 10 of FIG. 11 to one or more grounding elements 100 and a metal structure 102 is described. Initially, the base 18 and the main body 22 are removed from the clamping member 26, and the clamping member is positioned around the metal structure 102, as shown in FIG. 17. The main body 22 is then inserted onto the ends of the leg portions 104 and 108 of the clamping member 26, and the one or more grounding elements 100 are positioned in proximity to the conductor gripping member 69, seen in FIG. 12, of the first wall 68a of the main body 22. The base 18 is then inserted onto the ends of the leg portions 104 and 108, and fastening elements 120 are tightened to draw the main body 22, the base 18 and the one or more grounding elements 100 toward the metal structure 102. In this exemplary embodiment, the base 18 may be adjusted relative to the main body 22 to permit the clamp assembly 10 to receive different size grounding elements 100. To illustrate for the embodiment of FIG. 17, a position of the base 18 relative to the main body 22 may be adjusted by moving, e.g., by sliding, the base 18 along the two leg portions 104 and 108 toward or away from the main body 22. As another illustration, if the clamp assembly 10 of FIG. 11 includes the clamp body 126 and the fastener assemblies shown in FIG. 3, a position of the base 18 relative to the main body 22 may be adjusted by moving, e.g., by sliding, the base 18 along the two fastening elements 105 and 107 toward or away from the main body 22. As an exemplary result, sliding the base 18 away from the main body 22 increases one or more dimensions of the conductor channel 72, seen in FIG. 5, to permit larger size grounding elements 100 to be received by the conductor channel 72. Conversely, sliding the base 18 toward the main body 22 decreases one or more dimensions of the conductor channel 72 so that smaller size grounding elements 100 can be received by the conductor channel 72. In addition, the fastening elements 120 move the base 18 toward and possibly against the main body 22 removably or permanently attaching, clamping or otherwise securing or clamping the one or more grounding elements 100 within the conductor channel 72 between the base 18 and main body 22.

In addition, the main body 22 may also be adjustable relative to the metal structure 102 positioned within the clamp assembly 10 by moving the main body 22 along the respective clamping member or clamping members. To illustrate, for the exemplary embodiment of FIG. 17, the main body 22 may be adjusted to change the distance between the main portion 103 of the clamping member 26, e.g., a U-bolt type clamping member, and the structure contacting surface 88a of the main body 22. Sliding the main body 22 on the leg portions 104 and 108 of the clamping member 26 away from the main portion 103 of the clamping member increases the distance between the main portion 103 and the structure contacting surface 88a of the main body 22. Conversely, sliding the main body 22 on the leg portions 104 and 108 of the clamping member 26 toward the main portion 103 of the clamping member 26 decreases the distance between the main portion 103 and the structure contacting surface 88a of the main body 22. As such, the clamp assembly 10 is adjustable to receive different sizes of grounding elements 100 and structures 102 by changing the relative positions of the base 18, the main body 22 and the clamping member 26.

If the clamp assembly 10 of FIG. 11 includes the clamp body 126 and the two fastening elements 105 and 107 as the clamping member 26 shown in FIG. 3, the main body 22 may be adjusted to change the distance between the clamp body 126 and the structure contacting surface 88a of the main body 22. Sliding the main body 22 along the two bolts of the clamping member 26 away from the clamp body 126 increases the distance between the clamp body 126 and the structure contacting surface 88a of the main body 22. Conversely, sliding the main body 22 along the two bolts of the clamping member 26 toward the clamp body 126 decreases the distance between the clamp body 126 and the structure contacting surface 88a of the main body 22. As such, the clamp assembly 10 is adjustable to receive different sizes of grounding elements 100 and structures 102 by changing the relative positions of the base 18, the main body 22 and the clamp body 126.

With the clamp assembly 10 and one or more grounding elements 100 positioned on the metal structure 102, the fastening elements 120 are tightened to move the base 18 and the one or more grounding element 100 toward the main body 22, and the base 18, the one or more grounding elements 100 and main body 22 toward the structure 102 to establish an electrically conductive path therebetween. In this exemplary embodiment, structure 102 is a round helical pile shaft and the one or more grounding elements 100 are electrically conductive wires. As the fastening elements 120 are tightened the force, e.g., the compression force, applied by the one or more clamping members 26 on the base 18, the main body 22 and the structure 102 increases causing the one or more piercing members 16 extending from the bonding member 200 to contact the exterior of the structure 102. As the force is further increased, the one or more piercing members 16 pierce or cut through any coating on the exterior of the structure 102 creating an electrically conductive path between the structure 102, the bonding member 200 and the main body 22 so that an electrically conductive path is established between the one or more grounding elements 100 and the structure 102. In addition, as the force is increased the body 202 of the bonding member 200 may flex so that body 202 of the bonding member 200 conforms to the shape of the structure contacting surface 88a of the main body 22.

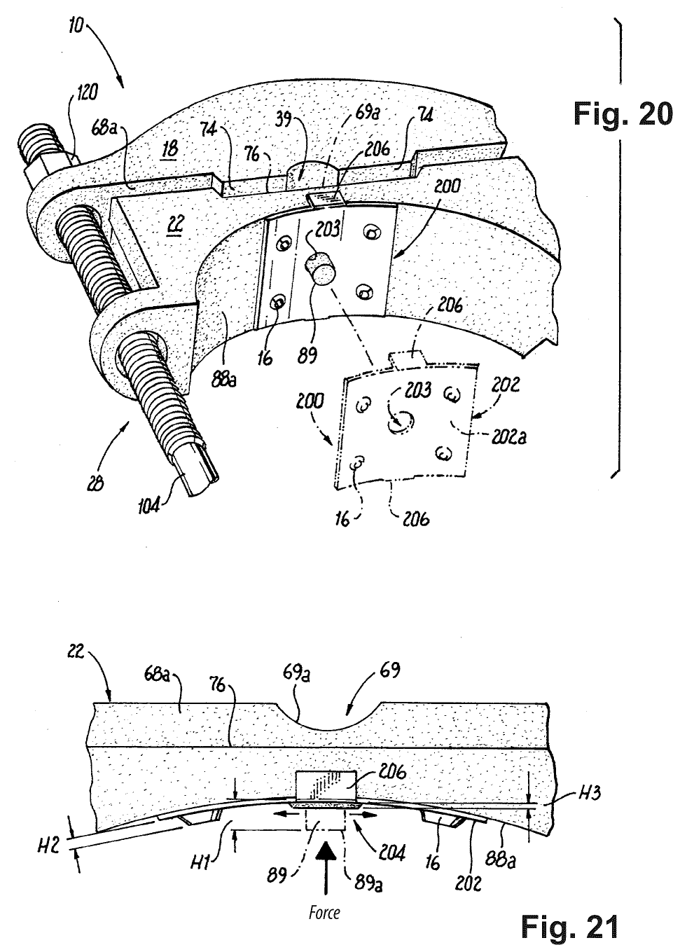

Referring now to FIGS. 20-24, another exemplary embodiment of a clamp assembly according to the present disclosure is shown. In this exemplary embodiment, clamp assembly 10 is substantially similar to the clamp assemblies 10 described above, except for bonding member 200, where the coupling of the bonding member 200 to the main body 22 differs. More specifically, one or more coupling members 204, seen in FIG. 21, of the bonding member 200 include one or more raised surfaces or one or more protrusions 89 that extend from the main body 22 and one or more apertures 203 in the body 202 of the bonding member 200. For case of description, the one or more raised surfaces or one or more protrusions 89 may be referred to collectively as the protrusions 89. Preferably, the protrusions 89 are generally centrally located on the contact surface 88a of the main body 22, as shown in FIG. 20. The protrusion 89 may be integral with or monolithically formed into the main body 22, or the protrusion 89 may be secured to the main body 22 using, for example, welds or adhesives. The protrusions 89 may also have a predetermined height “H1” shown in FIG. 21, which can vary for different bonding members 200. The predetermined height “H1” depends at least in part on the thickness of the body 202 of the bonding member 200 and/or the softness/hardness of the material of the main body 22. In the exemplary embodiment shown, the height “H1” is greater than the thickness of the body 202 of the bonding member 200 so that when the bonding member 200 is attached to the main body 22 a distal portion of the protrusions 89 can be deformed, by for example stamping, to secure the bonding member 200 to the main body 22. The one or more apertures 203 are generally centrally located through the body 202 so that one of the one or more apertures 203 align with one of the protrusions 89. The one or more apertures 203 are sized and dimensioned for receiving at least the distal portion of one of the protrusions 89 so that the distal portion of the protrusions 89 extends through a respective aperture 203.

Continuing to refer to FIGS. 20 and 21, the piercing members 16 of bonding member 200 are substantially the same as the piercing members 16 described above, except that the piercing members 16 may have a predetermined height “H2” shown in FIG. 21. The predetermined height “H2” depends at least in part on the thickness of the body 202 of the bonding member 200 and the height “H3” of the deformed protrusions 89. In the exemplary embodiment shown, the height “H2” of the piercing members 16 is sufficient to allow the piercing members 16 to contact the structure 102 when securing the clamp assembly 10 to the structure 102.

In this exemplary embodiment, the bonding member 200 may also include one or more alignment members 206 that extend from one or more sides of body 202 to limit and/or prevent rotation of the bonding member 200 relative to the structure 102 when attaching the clamp assembly 10 to the structure 102.

Referring again to FIGS. 20-24, securing the bonding member 200 to the main body 22 and establishing an electrically conductive path therebetween will be described. In this exemplary embodiment, the main body 22 includes a single protrusion 89 and the bonding member 200 includes a single aperture 203. The bonding member 200 is placed onto the main body 22 so that at least the distal portion of the protrusion 89 extends through the aperture 203 and the top surface 202a of the body 202 is in contact with the structure contacting surface 88a of the main body 22. A force, for example a striking, stamping or compression force is then exerted onto the distal portion 89a of the protrusion 89, such that the distal portion 89a of the protrusion 89 deforms, e.g., “mushrooms” or expands causing the diameter of the distal portion 89a of the protrusion 89 to be greater than the diameter of aperture 203 so as to removably or permanently attach, couple or otherwise secure the bonding member 200 to the main body 22.

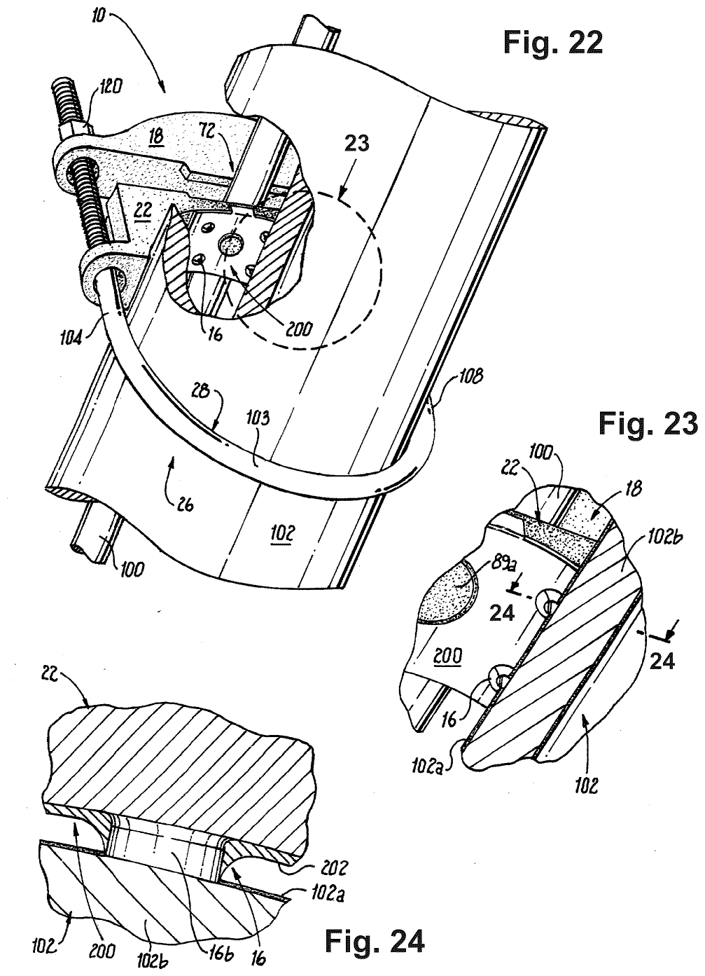

Referring again to FIGS. 22-24, an exemplary embodiment for removably or permanently attaching, coupling or otherwise securing or clamping the clamp assembly 10 of FIG. 20 to one or more grounding elements 100 and a metal structure 102 is described. Initially, the base 18 and the main body 22 are removed from the clamping member 26, and the clamping member is positioned around the metal structure 102 as shown in FIG. 22. The main body 22 is then inserted onto the ends of the leg portions 104 and 108 of the clamping member 26, and the one or more grounding elements 100 are positioned in proximity to the conductor gripping member 69, seen in FIG. 21, of the first wall 68a of the main body 22. The base 18 is then inserted onto the ends of the leg portions 104 and 108, and fastening elements 120 are tightened to move or draw the base 18 and one or more grounding elements 100 toward the main body 22, and to move or draw the base 18, one or more grounding elements 100 and the main body 22 toward the metal structure 102. In this exemplary embodiment, the base 18 may be adjusted relative to the main body 22 to permit the clamp assembly 10 to receive different size grounding elements 100. To illustrate for the embodiment of the clamp assembly 10 of FIG. 20, a position of the base 18 relative to the main body 22 may be adjusted by moving, e.g., by sliding, the base 18 along the two leg portions 104 and 108 toward or away from the main body 22. As another illustration, for the embodiment of the clamp assembly 10 that includes the clamp member 26 of FIG. 3, a position of the base 18 relative to the main body 22 may be adjusted by moving, e.g., by sliding, the base 18 along the two fastening elements 105 and 107 toward or away from the main body 22. As an exemplary result, sliding the base 18 away from the main body 22 increases one or more dimensions of conductor channel 72, seen in FIG. 5, to permit larger size grounding elements 100 to be received by the conductor channel 72. Conversely, sliding the base 18 toward the main body 22 decreases one or more dimensions of the conductor channel 72 so that smaller size grounding elements 100 can be received by conductor channel 72. In addition, the fastening elements 120 move the base 18 and one or more grounding elements 100 toward and possibly against the main body 22 removably or permanently attaching, coupling or otherwise securing or clamping the one or more grounding elements 100 within channel 72 between the base 18 and main body 22.

Continuing to refer to FIGS. 22-24, to permit the clamp assembly 10 to receive different size structures 102, the main body 22 may also be adjustable relative to the metal structure 102 by moving the main body 22 along the respective clamping member or clamping members 26. To illustrate, for the exemplary embodiment of the clamp assembly 10 of FIG. 22, the main body 22 may be adjusted to change the distance between the main portion 103 of the clamp body 28 and the structure contacting surface 88a of the main body 22. Sliding the main body 22 on the leg portions 104 and 108 of the clamping member 26 away from the main portion 103 of the clamp body 28 increases the distance between the main portion 103 and the structure contacting surface 88a of the main body 22. Conversely, sliding the main body 22 on the leg portions 104 and 108 of the clamping member 26 toward the main portion 103 of the clamp body 28 decreases the distance between the main portion 103 and the structure contacting surface 88a of the main body 22. As such, the clamp assembly 10 is adjustable to receive different sizes of grounding elements 100 and structures 102 by changing the relative positions of the base 18, the main body 22 and the clamp body 28 of the clamping member 26. As another illustration, if the clamp assembly 10 of FIG. 20 includes the clamp body 126 and the fastener assemblies shown in FIG. 3, the main body 22 may be adjusted to change the distance between the clamp body 126 and the structure contacting surface 88a of the main body 22. Sliding the main body 22 on the two fastening elements 105 and 107 away from the clamp body 126 increases the distance between the clamp body 126 and the structure contacting surface 88a of the main body 22. Conversely, sliding the main body 22 on the two fastening elements 105 and 107 toward the clamp body 126 decreases the distance between the clamp body 126 and the structure contacting surface 88a of the main body 22. As such, the clamp assembly 10 is adjustable to receive different sizes of grounding elements 100 and structures 102 by changing the relative positions of the base 18, the main body 22 and the clamp body 126.

With the clamp assembly 10 and one or more grounding elements 100 positioned on the metal structure 102, the fastening elements 120 are tightened to move the base 18 and one or more or draw grounding elements 100 toward the main body 22, and to move or draw the base 18, the one or more grounding elements 100 and main body 22 toward the structure 102 to establish an electrically conductive path therebetween. In this exemplary embodiment, structure 102 is a round helical pile shaft and the one or more grounding elements 100 are electrically conductive wires. As the fastening elements 120 are tightened, the force, e.g., the compression force, applied by the one or more clamping members 26 on the base 18, the main body 22 and the structure 102 increases causing the one or more piercing members 16 extending from the bonding member 200 to contact the exterior of the structure 102. As the force is further increased, the one or more piercing members 16 pierce or cut through any coating on the exterior of the structure 102, seen in FIG. 24, creating an electrically conductive path between the structure 102, the bonding member 200 and the main body 22 so that an electrically conductive path is established between the one or more grounding elements 100 and the structure 102. In addition, as the force is increased, the body 202 of the bonding member 200 may flex so that the body 202 conforms to the shape of the structure contacting surface 88a of the main body 22.

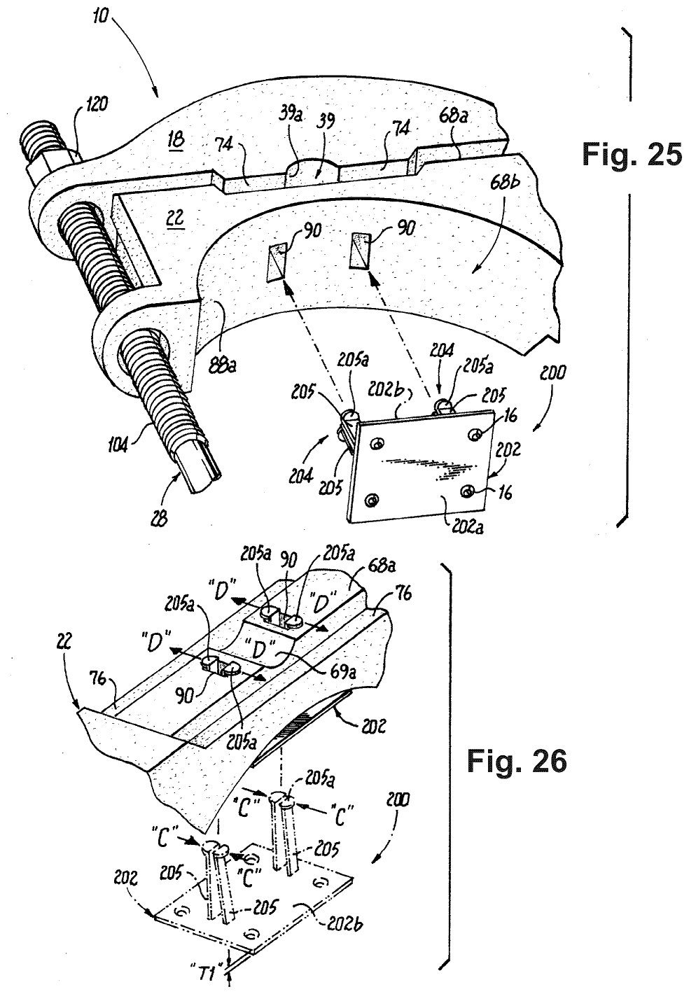

Referring now to FIGS. 25-29, another exemplary embodiment of a clamp assembly according to the present disclosure is shown. In this exemplary embodiment, clamp assembly 10 is substantially the same as the clamp assembly 10 described above, except for bonding member 200. More specifically, in the exemplary embodiment shown in FIGS. 25 and 26, the coupling members 204 of the bonding member 200 are different than the coupling members of the embodiments of the bonding member described above, and the attachment of the bonding member 200 to the main body 22 differs. In this exemplary embodiment, the bonding member 200 is similar to the embodiment of the bonding member 200 of FIG. 11 described above. The bonding member 200 includes an electrically conductive body 202 having a top surface 202a, a bottom surface 202b, one or more coupling members 204 and one or more piercing members 16. The body 202 can be of any shape or size, but is preferably configured and dimensioned to contact the structure contacting surface 88a of the second wall 68b of the main body 22. In the exemplary embodiment shown in FIGS. 25 and 26, the body 202 may be substantially flat and sufficiently flexible to conform to the shape of structure contacting surface 88a and/or the exterior of the structure 102 when force is applied on the bonding member 200 by the structure 102 when securing the clamp assembly 10 to the structure 102. In some embodiments, the body 202 may be shaped to match the shape of the structure contacting surface 88a such that the bottom surface 202a of the body 202 is in contact with the structure contacting surface 88a of the main body 22. For example, the structure contacting surface 88a may have an arcuate shape such that the body 202 is arcuate in shape, similar to that shown in FIG. 14, to conform to the arcuate shape of the structure contacting surface 88a. The body 202 may also have a predetermined thickness “T1,” seen in FIG. 26, which can vary for different bonding members 200. The predetermined thickness “T1” depends at least in part on the thickness of any coating on the exterior of the structure 102 and/or the anticipated or rated current the electrically conductive path is to carry. As a non-limiting example, the thickness “T1” may be in the range from about 0.125 mm to about 3 mm. The body 202 is made of an electrically conductive material that provides sufficient structural rigidity to establish and maintain an electrically conductive path between the structure 102 and the bonding member 200 when the clamp assembly 10 is attached to the structure 102. Non-limiting examples of the electrically conductive materials for the body 202 include stainless steel, brass, aluminum and/or aluminum alloy.

Continuing to refer to FIGS. 25 and 26, the coupling members 204 are provided to removably or permanently attach, couple or secure the bonding member 200 to the main body 22. In the exemplary embodiment shown, the coupling members 204 include one or more pairs of legs 205 extending from the bottom surface 202b of the body 202 of the bonding member 200. The legs 205 may be integral with or monolithically formed into the body 202, or the legs 205 may be secured to the body 202 using, for example, welds or adhesives. Each leg 205 includes clip arm 205a at a distal end of the leg 205. Each pair of legs 205 and corresponding clip arms 205a form the coupling member 204. Preferably, each pair of legs 205 and corresponding clip arms 205a, i.e., each coupling member 204, is configured and dimensioned to pass through one or more channels or slots 90 located through the main body 22, seen in FIG. 25, so that the coupling member 204 can pass into the second wall 68b through the main body 22 and exit the first wall 68a of the main body 22, as shown in FIGS. 25 and 26.

Continuing to refer to FIGS. 25 and 26, removably or permanently attaching, coupling or otherwise securing the bonding member 200 to the main body 22 to establish an electrically conductive path therebetween will be described. Each channel or slot 90 in the main body 22 is configured and dimensioned to receive a coupling member 204. The legs 205 are sufficiently flexible such that when a force is applied to the legs 205 in the direction of arrow “C”, e.g., pinched together, the distance between the outer most portion of the clip arms 205a decreases sufficient to permit the clip arms 205a to pass into the corresponding channel or slot 90. Once the clip arms 205a pass through slots 90, the force being applied to the legs 205 is removed allowing the clip arms 205a to spring back or return to their normal state, as shown by arrow “D” in FIG. 26. At this point, the distance between the clip arms 205a increases to its normal state so that the clip arms 205a are prevented from being withdrawn through the slots 90 so that the clip members secure the bonding member 200 to the main body 22.

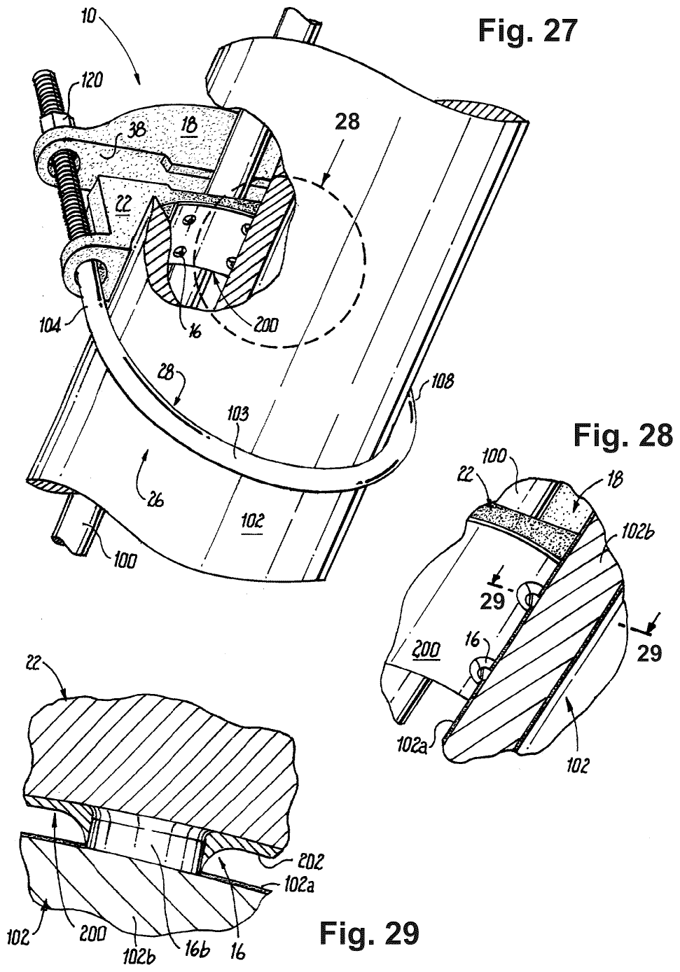

Referring to FIGS. 27-29, an exemplary embodiment for removably or permanently attaching, coupling or otherwise securing or clamping the clamp assembly 10 of FIG. 25 to one or more grounding elements 100 and a metal structure 102 is described. Initially, the base 18 and the main body 22 are removed from the clamping member 26, and the clamping member 26 is positioned around the metal structure 102 as shown in FIG. 27. The main body 22 is then inserted onto the ends of the leg portions 104 and 108 of the clamping member 26, and the one or more grounding elements 100 are positioned in proximity to the conductor gripping member 69, seen in FIG. 26, of the first wall 68a of the main body 22. The base 18 is then inserted onto the ends of the leg portions 104 and 108, and fastening elements 120 are tightened to move or draw the base 18 and one or more grounding elements 100 toward the main body 22, and to move or draw the base 18, one or more grounding elements 100 and the main body 22 toward the metal structure 102. In this exemplary embodiment, the base 18 may be adjusted relative to the main body 22 to permit the clamp assembly 10 to receive different size grounding elements 100. To illustrate for the embodiment of the clamp assembly 10 of FIG. 25, a position of the base 18 relative to the main body 22 may be adjusted by moving, e.g., by sliding, the base 18 along the two leg portions 104 and 108 toward or away from the main body 22. As another illustration, for the embodiment of the clamp assembly 10 that includes the clamp member 26 of FIG. 3, a position of the base 18 relative to the main body 22 may be adjusted by moving, e.g., by sliding, the base 18 along the two fastening elements 105 and 107 toward or away from the main body 22. As an exemplary result, sliding the base 18 away from the main body 22 increases one or more dimensions of the conductor channel 72, seen in FIG. 5, to permit larger size grounding elements 100 to be received by the conductor channel 72. Conversely, sliding the base 18 toward the main body 22 decreases one or more dimensions of the conductor channel 72 so that smaller size grounding elements 100 can be received by conductor channel 72. In addition, the fastening elements 120 move the base 18 and one or more grounding elements 100 toward and possibly against the main body 22 removably or permanently attaching, coupling or otherwise securing or clamping the one or more grounding elements 100 within channel 72 between the base 18 and main body 22.

Continuing to refer to FIGS. 27-29, to permit the clamp assembly 10 to receive different size structures 102, the main body 22 may also be adjustable relative to the metal structure 102 by moving the main body 22 along the respective clamping member or clamping members 26. To illustrate, for the exemplary embodiment of the clamp assembly of FIG. 25, the main body 22 may be adjusted to change the distance between the main portion 103 of the clamp body 28 and the structure contacting surface 88a of the main body 22. Sliding the main body 22 on the leg portions 104 and 108 of the clamping member 26 away from the main portion 103 of the clamp body 28 increases the distance between the main portion 103 and the structure contacting surface 88a of the main body 22. Conversely, sliding the main body 22 on the leg portions 104 and 108 of the clamping member 26 toward the main portion 103 of the clamp body 28 decreases the distance between the main portion 103 and the structure contacting surface 88a of the main body 22. As such, the clamp assembly 10 is adjustable to receive different sizes of grounding elements 100 and structures 102 by changing the relative positions of the base 18, the main body 22 and the clamp body 28 of the clamping member 26. As another illustration, if the clamp assembly 10 of FIG. 25 includes the clamp body 126 and the fastener assemblies shown in FIG. 3, the main body 22 may be adjusted to change the distance between the clamp body 126 and the structure contacting surface 88a of the main body 22. Sliding the main body 22 on the two fastening elements 105 and 107 of the fastener assemblies away from the clamp body 126 increases the distance between the clamp body 126 and the structure contacting surface 88a of the main body 22. Conversely, sliding the main body 22 on the two fastening elements 105 and 107 toward the clamp body 126 decreases the distance between the clamp body 126 and the structure contacting surface 88a of the main body 22. As such, the clamp assembly 10 is adjustable to receive different sizes of grounding elements 100 and structures 102 by changing the relative positions of the base 18, the main body 22 and the clamp body 126.

With the clamp assembly 10 and one or more grounding elements 100 positioned on the metal structure 102, the fastening elements 120 are tightened to move or draw the base 18 and one or more grounding elements 100 toward the main body 22, and to move or draw the base 18, the one or more grounding elements 100 and main body 22 toward the structure 102 to establish an electrically conductive path therebetween. In this exemplary embodiment, structure 102 is a round helical pile shaft and the one or more grounding elements 100 are electrically conductive wires. As the fastening elements 120 are tightened, the force, e.g., the compression force, applied by the one or more clamping members 26 on the base 18, the main body 22 and the structure 102 increases causing the one or more piercing members 16 extending from the bonding member 200 to contact the exterior of the structure 102. As the force is further increased, the one or more piercing members 16 pierce or cut through any coating on the exterior of the structure 102 creating an electrically conductive path between the structure 102, the bonding member 200 and the main body 22 so that an electrically conductive path is established between the one or more grounding elements 100 and the structure 102. In addition, as the force is increased the body 202 of the bonding member 200 may flex so that body 202 of the bonding member 200 conforms to the shape of the structure contacting surface 88a of the main body 22.

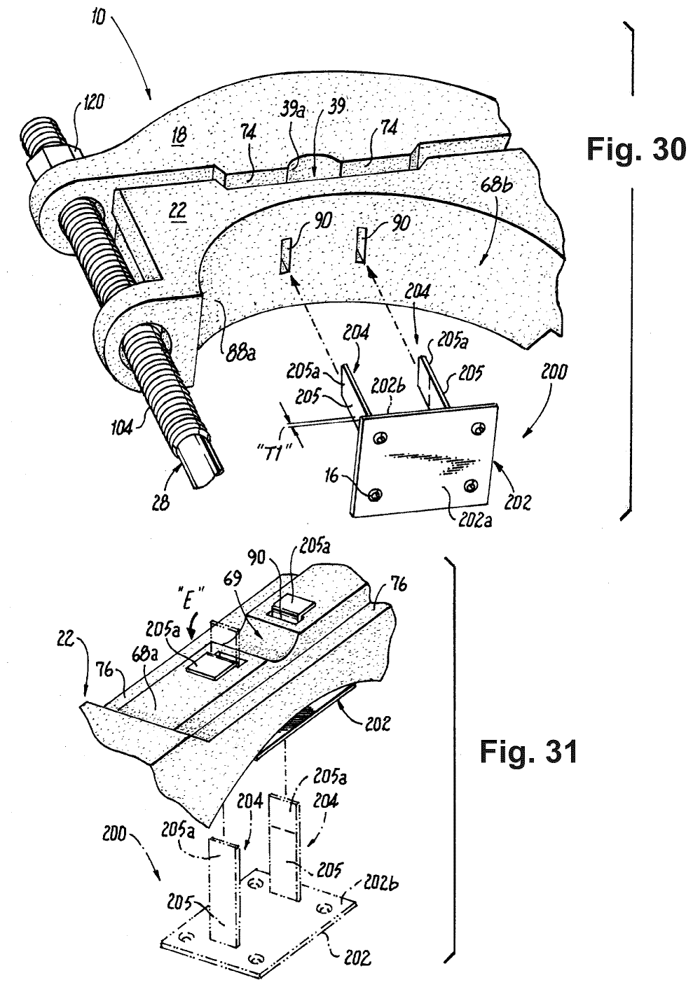

Referring now to FIGS. 30-34, another exemplary embodiment of a clamp assembly according to the present disclosure is shown. In this exemplary embodiment, clamp assembly 10 is substantially the same as the clamp assembly 10 described above, except for bonding member 200. More specifically, in the exemplary embodiment shown in FIGS. 30-34, the coupling members 204 of the bonding member 200 are different than the coupling members of the embodiments of the bonding member described above, and the attachment of the bonding member 200 to the main body 22 differs. In this exemplary embodiment, the bonding member 200 is similar to the embodiment of the bonding member 200 of FIG. 25 described above. The bonding member 200 includes an electrically conductive body 202 having a top surface 202a, a bottom surface 202b, one or more coupling members 204 and one or more piercing members 16. The body 202 can be of any shape or size, but is preferably configured and dimensioned to contact the structure contacting surface 88a of the second wall 68b of the main body 22. In the exemplary embodiment shown in FIGS. 30 and 31, the body 202 may be substantially flat and sufficiently flexible to conform to the shape of structure contacting surface 88a and/or the exterior of the structure 102 when force is applied on the bonding member 200 by the structure 102 when securing the clamp assembly 10 to the structure 102. In some embodiments, the body 202 may be shaped to match the shape of the structure contacting surface 88a such that the bottom surface 202b of the body 202 is in contact with the structure contacting surface 88a of the main body 22. For example, in this embodiment, the structure contacting surface 88a has an arcuate shape such that the body 202 is arcuate in shape, similar to that shown in FIG. 14, to conform to the arcuate shape of the structure contacting surface 88a. The body 202 may also have a predetermined thickness “T1,” seen in FIG. 31, which can vary for different bonding members 200. The predetermined thickness “T1” depends at least in part on the thickness of any coating on the exterior of the structure 102 and/or the anticipated or rated current the electrically conductive path is to carry. As a non-limiting example, the thickness “T1” may be in the range from about 0.125 mm to about 3 mm. The body 202 is made of an electrically conductive material that provides sufficient structural rigidity to establish and maintain an electrically conductive path between the structure 102 and the bonding member 200 when the clamp assembly 10 is attached to the structure 102. Non-limiting examples of the electrically conductive materials for the body 202 include stainless steel, brass, aluminum and/or aluminum alloy.

Continuing to refer to FIGS. 30 and 31, the coupling members 204 are provided to attach the bonding member 200 to the main body 22. In the exemplary embodiment shown, the coupling members 204 include one or more legs 205 extending from the bottom surface 202b of the body 202 of the bonding member 200. The legs 205 may be integral with or monolithically formed into the body 202, or the legs 205 may be secured to the body 202 using, for example, welds or adhesives. Preferably, each leg 205 is configured and dimensioned to pass through one or more channels or slots 90 located through the main body 22, seen in FIG. 30, so that the leg 205 can pass into the second wall 68b through the main body 22 and exit the first wall 68a of the main body 22, as shown in FIGS. 30 and 31. Similarly, each channel or slot 90 in the main body 22 is configured and dimensioned to receive a leg 205 of the coupling members 204. To removably or permanently attach, couple or otherwise secure the bonding member 200 to the main body 22 to establish an electrically conductive path therebetween, the bonding member 200 is positioned adjacent the second wall 68b of the main body 22 so that the bottom surface 202b of the body 202 faces the structure contacting surface 88a of the second wall 68b. The distal ends 205a of the legs 205 are then inserted into the slots 90. Once the legs 205 pass through slots 90, a distal end 205a, seen in FIG. 31, of the legs 205 are deformed, e.g., bent in, for example, the direction of arrow “E,” to hold the bonding member 200 in position relative to the main body 22 and to prevent the legs 205 from being withdrawn through the slots 90 so that the coupling members 204 removably or permanently attach, couple or otherwise secure the bonding member 200 to the main body 22.

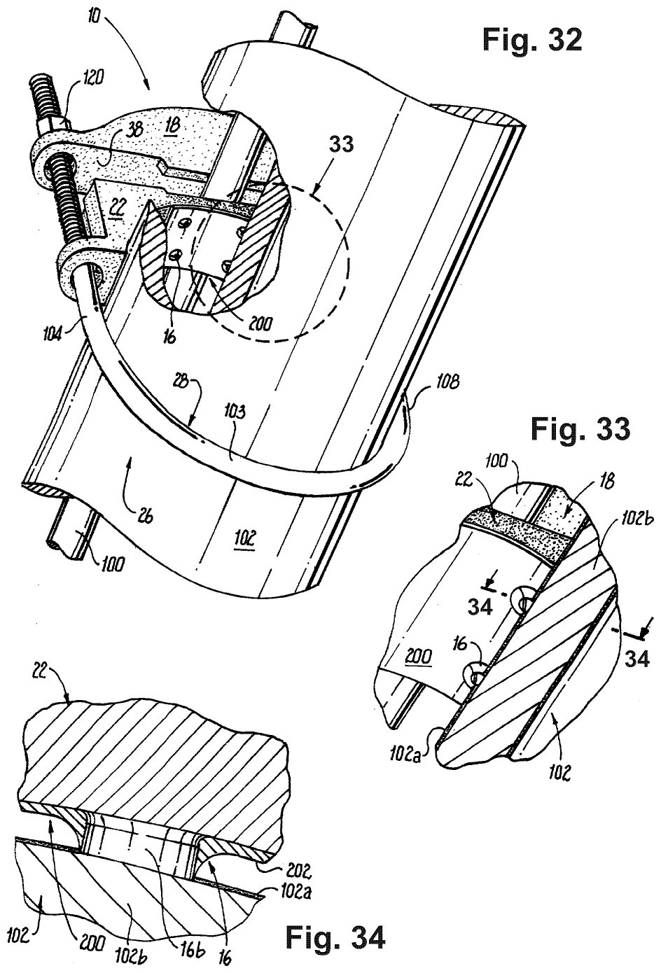

Referring again to FIGS. 32-34, an exemplary embodiment for removably or permanently attaching, coupling or otherwise securing or clamping the clamp assembly 10 of FIG. 30 to one or more grounding elements 100 and a metal structure 102 is described. Initially, the base 18 and the main body 22 are removed from the clamping member 26, and the clamping member is positioned around the metal structure 102 as shown in FIG. 32. The main body 22 is then inserted onto the ends of the leg portions 104 and 108 of the clamping member 26, and the one or more grounding elements 100 are positioned in proximity to the conductor gripping member 69, seen in FIG. 31, of the first wall 68a of the main body 22. The base 18 is then inserted onto the ends of the leg portions 104 and 108, and fastening elements 120 are tightened to move or draw the base 18 and one or more grounding elements 100 toward the main body 22, and to move or draw the base 18, one or more grounding elements 100 and the main body 22 toward the metal structure 102. In this exemplary embodiment, the base 18 may be adjusted relative to the main body 22 to permit the clamp assembly 10 to receive different size grounding elements 100. To illustrate for the embodiment of the clamp assembly 10 of FIG. 30, a position of the base 18 relative to the main body 22 may be adjusted by moving, e.g., by sliding, the base 18 along the two leg portions 104 and 108 toward or away from the main body 22. As another illustration, for the embodiment of the clamp assembly 10 that includes the clamping member 26 of FIG. 3, a position of the base 18 relative to the main body 22 may be adjusted by moving, e.g., by sliding, the base 18 along the two fastening elements 105 and 107 toward or away from the main body 22. As an exemplary result, sliding the base 18 away from the main body 22 increases one or more dimensions of the conductor channel 72, seen in FIG. 5, to permit larger size grounding elements 100 to be received by the conductor channel 72. Conversely, sliding the base 18 toward the main body 22 decreases one or more dimensions of the conductor channel 72 so that smaller size grounding elements 100 can be received by conductor channel 72. In addition, the fastening elements 120 move the base 18 and one or more grounding elements 100 toward and possibly against the main body 22 removably or permanently attaching, coupling or otherwise securing or clamping the one or more grounding elements 100 within channel 72 between the base 18 and main body 22.

Continuing to refer to FIGS. 32-34, to permit the clamp assembly 10 to receive different size structures 102, the main body 22 may also be adjustable relative to the metal structure 102 by moving the main body 22 along the respective clamping member or clamping members 26. To illustrate, for the exemplary embodiment of the clamp assembly of FIG. 30, the main body 22 may be adjusted to change the distance between the main portion 103 of the clamp body 28 and the structure contacting surface 88a of the main body 22. Sliding the main body 22 on the leg portions 104 and 108 of the clamping member 26 away from the main portion 103 of the clamp body 28 increases the distance between the main portion 103 and the structure contacting surface 88a of the main body 22. Conversely, sliding the main body 22 on the leg portions 104 and 108 of the clamping member 26 toward the main portion 103 of the clamp body 28 decreases the distance between the main portion 103 and the structure contacting surface 88a of the main body 22. As such, the clamp assembly 10 is adjustable to receive different sizes of grounding elements 100 and structures 102 by changing the relative positions of the base 18, the main body 22 and the clamp body 28 of the clamping member 26. As another illustration, if the clamp assembly 10 of FIG. 30 includes the clamp body 126 and the fastener assemblies shown in FIG. 3, the main body 22 may be adjusted to change a distance between the clamp body 126 and the structure contacting surface 88a of the main body 22. Sliding the main body 22 on the two fastening elements 105 and 107 of the fastener assemblies away from the clamp body 126 increases the distance between the clamp body 126 and the structure contacting surface 88a of the main body 22. Conversely, sliding the main body 22 on the two fastening elements 105 and 107 toward the clamp body 126 decreases the distance between the clamp body 126 and the structure contacting surface 88a of the main body 22. As such, the clamp assembly 10 is adjustable to receive different sizes of grounding elements 100 and structures 102 by changing the relative positions of the base 18, the main body 22 and the clamp body 126.

With the clamp assembly 10 and one or more grounding elements 100 positioned on the metal structure 102, the fastening elements 120 are tightened to move or draw the base 18 and one or more grounding elements 100 toward the main body 22, and to move or draw the base 18, the one or more grounding elements 100 and main body 22 toward the structure 102 to establish an electrically conductive path therebetween. In this exemplary embodiment, structure 102 is a round helical pile shaft and the one or more grounding elements 100 are electrically conductive wires. As the fastening elements 120 are tightened, the force, e.g., the compression force, applied by the one or more clamping members 26 on the base 18, the main body 22 and the structure 102 increases causing the one or more piercing members 16 extending from the bonding member 200 to contact the exterior of the structure 102. As the force is further increased, the one or more piercing members 16 pierce or cut through any coating on the exterior of the structure 102, seen in FIG. 34, creating an electrically conductive path between the structure 102, the bonding member 200 and the main body 22 so that an electrically conductive path is established between the one or more grounding elements 100 and the structure 102. In addition, as the force is increased the body 202 of the bonding member 200 may flex so that body 202 of the bonding member 200 conforms to the shape of the structure contacting surface 88a of the main body 22.

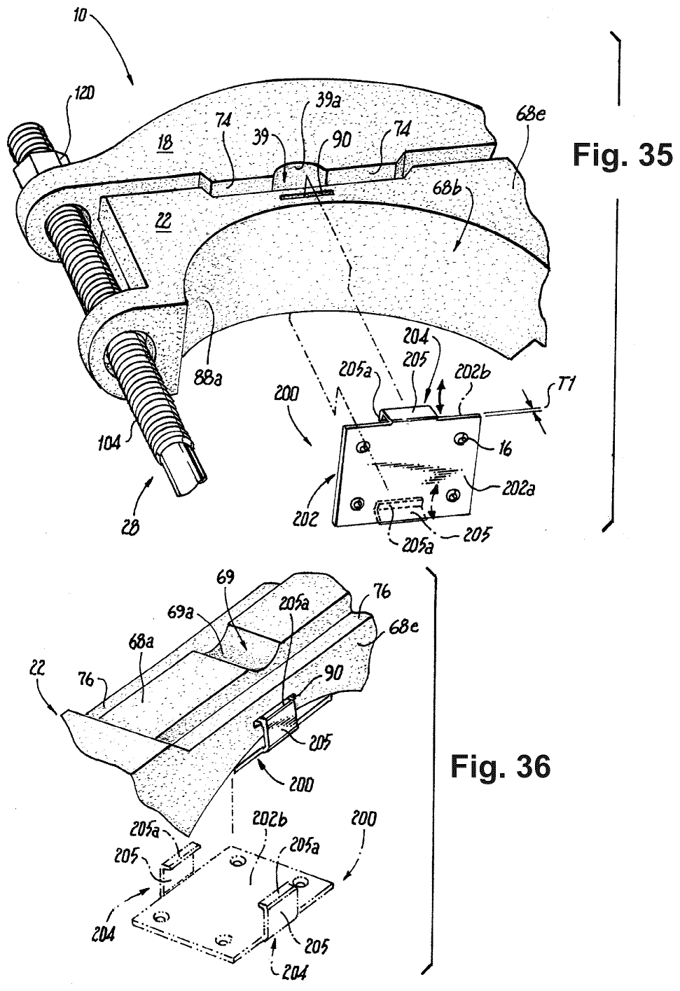

Referring now to FIGS. 35-39, another exemplary embodiment of a clamp assembly according to the present disclosure is shown. In this exemplary embodiment, clamp assembly 10 is substantially the same as the clamp assembly 10 described above, except for bonding member 200. More specifically, in the exemplary embodiment shown in FIGS. 35-39, the coupling members 204 of the bonding member 200 are different than the coupling members of the embodiments of the bonding member described above, and the attachment of the bonding member 200 to the main body 22 differs. In this exemplary embodiment, the bonding member 200 is similar to the embodiment of the bonding member 200 of FIG. 30 described above. The bonding member 200 includes an electrically conductive body 202 having a top surface 202a, a bottom surface 202b, one or more coupling members 204 and one or more piercing members 16. The body 202 can be of any shape or size, but is preferably configured and dimensioned to contact the structure contacting surface 88a of the second wall 68b of the main body 22. In the exemplary embodiment shown in FIGS. 35 and 36, the body 202 may be substantially flat and sufficiently flexible to conform to the shape of structure contacting surface 88a and/or the exterior of the structure 102 when force is applied on the bonding member 200 by the structure 102 when securing the clamp assembly 10 to the structure 102. In another exemplary embodiment, the body 202 may be shaped to match the shape of the structure contacting surface 88a such that the bottom surface 202b of the body 202 is in contact with the structure contacting surface 88a of the main body 22. For example, in this exemplary embodiment, the structure contacting surface 88a has an arcuate shape such that the body 202 is arcuate in shape, similar to that shown in FIG. 14, to conform to the arcuate shape of the structure contacting surface 88a. The body 202 may also have a predetermined thickness “T1,” seen in FIG. 35, which can vary for different bonding members 200. The predetermined thickness “T1” depends at least in part on the thickness of any coating on the exterior of the structure 102 and/or the anticipated or rated current the electrically conductive path is to carry. As a non-limiting example, the thickness “T1” may be in the range from about 0.125 mm to about 3 mm. The body 202 is made of an electrically conductive material that provides sufficient structural rigidity to establish and maintain an electrically conductive path between the structure 102 and the bonding member 200 when the clamp assembly 10 is attached to the structure 102. Non-limiting examples of the electrically conductive materials for the body 202 include stainless steel, brass, aluminum and/or aluminum alloy.

Continuing to refer to FIGS. 35 and 36, the coupling members 204 are provided to removably or permanently attach, couple or otherwise secure the bonding member 200 to the main body 22. In the exemplary embodiment shown, the coupling members 204 include one or more legs 205 extending from a side edge of the body 202 of the bonding member 200. The legs 205 may be integral with or monolithically formed into the side edge of the body 202, or the legs 205 may be secured to the side edge of the body 202 using, for example, welds or adhesives. Preferably, each leg 205 includes a distal end 205a, seen in FIG. 36, that is configured and dimensioned to fit into one or more channels or slots 90 located in the side walls 68e and 68f of the main body 22, seen in FIG. 35. The distal end 205a of each leg 205 is at an angle relative to the body 202 so that the distal end 205a can enter the channels or slots 90, seen in FIG. 36. Preferably, the distal end 205a of each leg 205 is substantially at a right angle relative to the body 202. Each channel or slot 90 located in the side walls 68e and 68f of the main body 22 is configured and dimensioned to receive the distal portion 205a of the legs 205 of the coupling members 204. To connect the bonding member 200 to the main body 22 to establish an electrically conductive path therebetween, the bonding member 200 is positioned adjacent the second wall 68b of the main body 22 so that the bottom surface 202b of the body 202 faces the structure contacting surface 88a of the second wall 68b. The distal ends 205a of the legs 205 are then flexed, e.g., flexed outwardly, to permit the distal ends 205a to slide along the side walls 68c and 68f of the main body 22 toward the slots 90. Once the distal ends 205a of the legs 205 reach the slots 90, the force holding the legs 205 apart is removed so that the distal ends 205a spring back or return to their normal state and enter the slots 90 to hold the bonding member 200 in position relative to the main body 22 and to prevent the legs 205 from being withdrawn from the slots 90 so that the coupling members 204 removably or permanently attach, couple or otherwise secure the bonding member 200 to the main body 22.

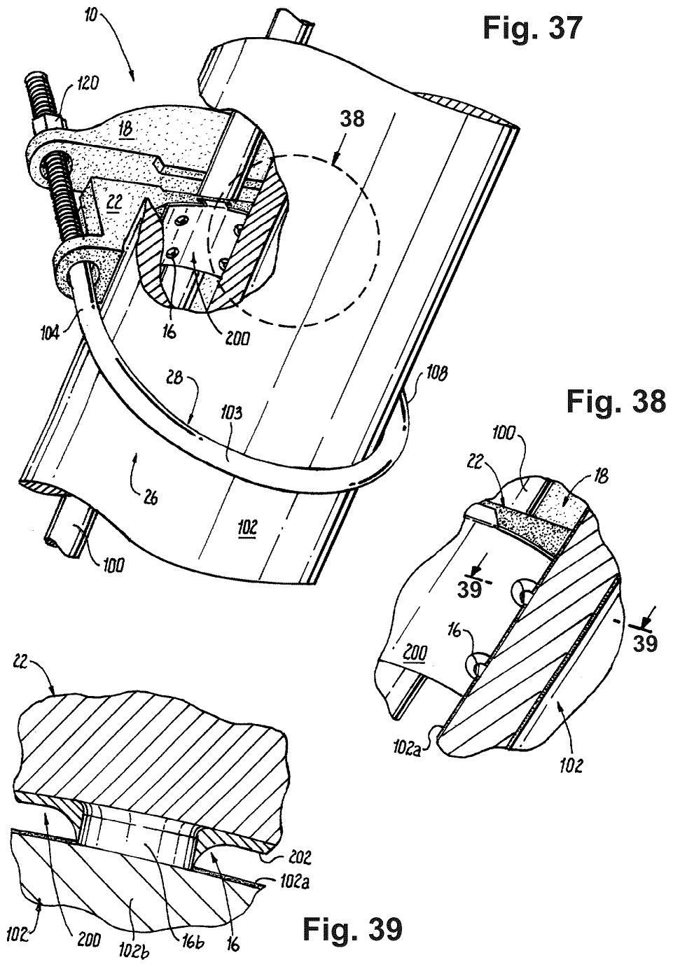

Referring again to FIGS. 37-39, an exemplary embodiment for removably or permanently attaching, coupling or otherwise securing or clamping the clamp assembly 10 of FIG. 35 to one or more grounding elements 100 and a metal structure 102 is described. Initially, the base 18 and the main body 22 are removed from the clamping member 26, and the clamping member is positioned around the metal structure 102 as shown in FIG. 37. The main body 22 is then inserted onto the ends of the leg portions 104 and 108 of the clamping member 26, and the one or more grounding elements 100 are positioned in proximity to the conductor gripping member 69, seen in FIG. 36, of the first wall 68a of the main body 22. The base 18 is then inserted onto the ends of the leg portions 104 and 108, and fastening elements 120 are tightened to move or draw the base 18 and one or more grounding elements 100 toward the main body 22, and to move or draw the base 18, one or more grounding elements 100 and the main body 22 toward the metal structure 102. In this exemplary embodiment, the base 18 may be adjusted relative to the main body 22 to permit the clamp assembly 10 to receive different size grounding elements 100. To illustrate for the embodiment of the clamp assembly 10 of FIG. 35, a position of the base 18 relative to the main body 22 may be adjusted by moving, e.g., by sliding, the base 18 along the two leg portions 104 and 108 toward or away from the main body 22. As another illustration, for the embodiment of the clamp assembly 10 that includes the clamping member 26 of FIG. 3, a position of the base 18 relative to the main body 22 may be adjusted by moving, e.g., by sliding, the base 18 along the two fastening elements 105 and 107 toward or away from the main body 22. As an exemplary result, sliding the base 18 away from the main body 22 increases one or more dimensions of the conductor channel 72, seen in FIG. 5, to permit larger size grounding elements 100 to be received by the conductor channel 72. Conversely, sliding the base 18 toward the main body 22 decreases one or more dimensions of the conductor channel 72 so that smaller size grounding elements 100 can be received by the conductor channel 72. In addition, the fastening elements 120 move the base 18 and one or more grounding elements 100 toward and possibly against the main body 22 removably or permanently attaching, coupling or otherwise securing or clamping the one or more grounding elements 100 within channel 72 between the base 18 and main body 22.

Continuing to refer to FIGS. 37-39, to permit the clamp assembly 10 to receive different size structures 102, the main body 22 may also be adjustable relative to the metal structure 102 by moving the main body 22 along the respective clamping member or clamping members 26. To illustrate, for the exemplary embodiment of the clamp assembly of FIG. 35, the main body 22 may be adjusted to change a distance between the main portion 103 of the clamp body 28 and the structure contacting surface 88a of the main body 22. Sliding the main body 22 on the leg portions 104 and 108 of the clamping member 26 away from the main portion 103 of the clamp body 28 increases the distance between the main portion 103 and the structure contacting surface 88a of the main body 22. Conversely, sliding the main body 22 on the leg portions 104 and 108 of the clamping member 26 toward the main portion 103 of the clamp body 28 decreases the distance between the main portion 103 and the structure contacting surface 88a of the main body 22. As such, the clamp assembly 10 is adjustable to receive different sizes of grounding elements 100 and structures 102 by changing the relative positions of the base 18, the main body 22 and the clamp body 28 of the clamping member 26. As another illustration, if the clamp assembly 10 of FIG. 35 includes the clamp body 126 and the fastener assemblies shown in FIG. 3, the main body 22 may be adjusted to change a distance between the clamp body 126 and the structure contacting surface 88a of the main body 22. Sliding the main body 22 on the two fastening elements 105 and 107 of the fastener assemblies away from the clamp body 126 increases the distance between the clamp body 126 and the structure contacting surface 88a of the main body 22. Conversely, sliding the main body 22 on the two fastening elements 105 and 107 toward the clamp body 126 decreases the distance between the clamp body 126 and the structure contacting surface 88a of the main body 22. As such, the clamp assembly 10 is adjustable to receive different sizes of grounding elements 100 and structures 102 by changing the relative positions of the base 18, the main body 22 and the clamp body 126.

With the clamp assembly 10 and one or more grounding elements 100 positioned on the metal structure 102, the fastening elements 120 are tightened to move or draw the base 18 and one or more grounding elements 100 toward the main body 22, and to move or draw the base 18, the one or more grounding elements 100 and main body 22 toward the structure 102 to establish an electrically conductive path therebetween. In this exemplary embodiment, structure 102 is a round helical pile shaft and the one or more grounding elements 100 are electrically conductive wires. As the fastening elements 120 are tightened, the force, e.g., the compression force, applied by the one or more clamping members 26 on the base 18, the main body 22 and the structure 102 increases causing the one or more piercing members 16 extending from the bonding member 200 to contact the exterior of the structure 102. As the force is further increased, the one or more piercing members 16 pierce or cut through any coating on the exterior of the structure 102 creating an electrically conductive path between the structure 102, the bonding member 200 and the main body 22 so that an electrically conductive path is established between the one or more grounding elements 100 and the structure 102. In addition, as the force is increased the body 202 of the bonding member 200 may flex so that body 202 of the bonding member 200 conforms to the shape of the structure contacting surface 88a of the main body 22.

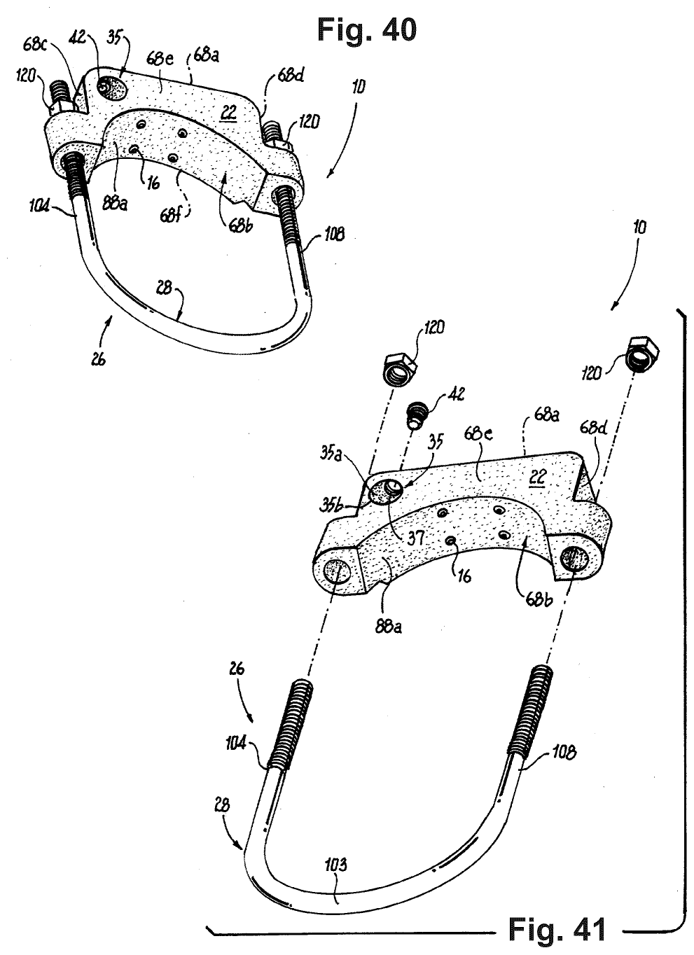

Referring now to FIGS. 40-44, another exemplary embodiment of a clamp assembly according to the present disclosure is shown. In this exemplary embodiment, clamp assembly 10 includes a main body 22 and a clamping member 26. The main body 22 is substantially similar to the main body 22 described above, except that the main body 22 includes a grounding element connector 35. Generally, the main body 22 includes a first wall 68a, a second wall 68b opposite the first wall, a third wall 68c, a fourth wall 68d opposite the third wall 68c, and two sides 68c, 68f that connect the walls 68a-68d. The sides 68e, 68f include the bore 35 extending therethrough. In the embodiment shown, the grounding element connector 35 includes a bore 35a and a fastening element 42. The bore 35a is configured and dimensioned to receive one or more grounding elements 100, such as wires, cables or rods. As such, the size of the bore 35a should be rated to receive the size of the one or more grounding elements 100 to be used to bond and/or ground the clamp assembly 10. To illustrate, if the clamp assembly 10 is clamping a single grounding element 100 and the grounding element 100 is a 10 AWG wire, the bore 35a should be rated to receive a 10 AWG wire. The bore 35a includes a contact surface 35b that may form part of an electrically conductive path between the one or more grounding elements 100 and the main body 22. The contact surface 35b may include a surface gripping feature, such as for example, teeth, ridges or knurling. In the exemplary embodiment shown, the first wall 68a of the main body 22 includes a threaded aperture 37 therethrough that intersects with the bore 35a. The aperture 37 is configured and dimensioned to receive the fastening element 42, such as a set screw, used to secure the one or more grounding elements 100 to the main body 22. It will be appreciated that the aperture 37 may be located along any of the walls of the main body 22 so long as aperture 37 intersects with the bore 35a.

Continuing to refer to FIGS. 40-44, the second wall 68b of the main body 22 includes the structure contacting surface 88a. The structure contacting surface 88a is configured and dimensioned to receive at least a portion of the structure 102, e.g., a post or pole, the clamp assembly 10 is to be attached. In the exemplary embodiment shown, the structure contacting surface 88a is arcuate in shape. However, the present disclosure contemplates other shapes for the structure contacting surface 88a. The structure contacting surface 88a of the second wall 68b is in facing relationship relative to the one or more clamping members 26. As described herein, the structure contacting surface 88a includes one or more piercing members 16. In the embodiment shown in FIGS. 40 and 41, the structure contacting surface 88a has four piercing members 16 positioned on a central portion of the second wall 68b of the main body 22. It is contemplated within this disclosure that there may be more or fewer piercing members 16 located at any location on the contact surface 88a.

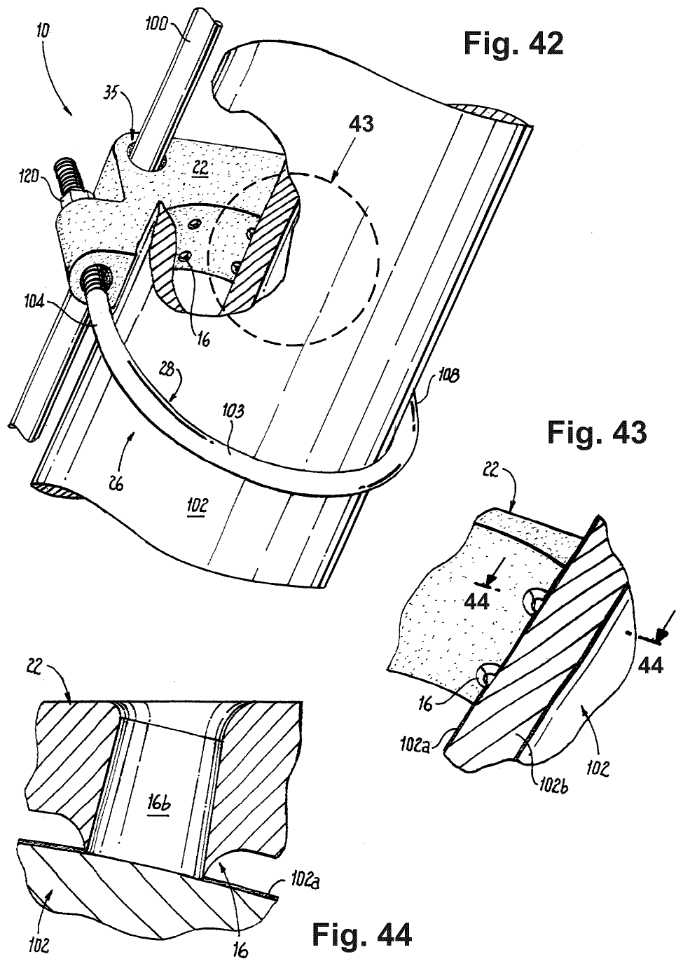

Referring to FIGS. 42-44, an exemplary embodiment for removably or permanently attaching, coupling or otherwise securing or clamping the clamp assembly 10 of FIGS. 40 and 41 to one or more grounding elements 100 and a metal structure 102 is described. Initially, the main body 22 is removed from the clamping member 26, and the clamping member is positioned around the metal structure 102 as shown in FIG. 42. The one or more grounding elements 100 are passed through the bore 35a of the grounding element connector 35 and the fastening element 42 of the grounding element connector 35 is tightened to removably or permanently attach, couple or otherwise secure the one or more grounding elements 100 to the main body 22. With the one or more grounding elements secured to the main body, the main body 22 is then inserted onto the ends of the leg portions 104 and 108 of the clamping member 26, and the fastening elements 120 are tightened to move or draw the main body 22 and the one or more grounding elements 100 toward the metal structure 102. To permit the clamp assembly 10 to receive different size structures 102, the main body 22 may be adjustable relative to the metal structure 102 by moving the main body 22 along the respective clamping member or clamping members 26. To illustrate, for the exemplary embodiment of the clamp assembly of FIGS. 40 and 41, the main body 22 may be adjusted to change a distance between the main portion 103 of the clamp body 28 and the structure contacting surface 88a of the main body 22. Sliding the main body 22 on the leg portions 104 and 108 of the clamping member 26 away from the main portion 103 of the clamp body 28 increases the distance between the main portion 103 and the structure contacting surface 88a of the main body 22. Conversely, sliding the main body 22 on the leg portions 104 and 108 of the clamping member 26 toward the main portion 103 of the clamp body 28 decreases the distance between the main portion 103 and the structure contacting surface 88a of the main body 22. As such, the clamp assembly 10 is adjustable to receive different size structures 102 by changing the relative position of the main body 22 and the clamp body 28 of the clamping member 26. As another illustration, if the clamp assembly 10 of FIGS. 40 and 41 includes the clamp body 126 and the fastener assemblies shown in FIG. 3, the main body 22 may be adjusted to change a distance between the clamp body 126 and the structure contacting surface 88a of the main body 22. Sliding the main body 22 on the two fastening elements 105 and 107 of the fastener assemblies away from the clamp body 126 increases the distance between the clamp body 126 and the structure contacting surface 88a of the main body 22. Conversely, sliding the main body 22 on the two fastening elements 105 and 107 toward the clamp body 126 decreases the distance between the clamp body 126 and the structure contacting surface 88a of the main body 22. As such, the clamp assembly 10 is adjustable to receive different size and structures 102 by changing the relative position of the main body 22 and the clamp body 126.

With the clamp assembly 10 and one or more grounding elements 100 positioned on the metal structure 102, the fastening elements 120 are tightened to move or draw the main body 22 and one or more grounding elements 100 toward the structure 102 to establish an electrically conductive path therebetween. In this exemplary embodiment, structure 102 is a round helical pile shaft and the one or more grounding elements 100 are electrically conductive wires. As the fastening elements 120 are tightened, the force, e.g., the compression force, applied by the one or more clamping members 26 on the main body 22 and the structure 102 increases causing the one or more piercing members 16 extending from the main body 22 to contact the exterior of the structure 102. As the force is further increased, the one or more piercing members 16 pierce or cut through any coating on the exterior of the structure 102 creating an electrically conductive path between the structure 102 and the main body 22 so that an electrically conductive path is established between the one or more grounding elements 100 and the structure 102.

While illustrative embodiments of the present disclosure have been described and illustrated above, it should be understood that these are exemplary of the disclosure and are not to be considered as limiting. Additions, deletions, substitutions, and other modifications can be made without departing from the spirit or scope of the present disclosure. Accordingly, the present disclosure is not to be considered as limited by the foregoing description.

What is claimed is:

1. A clamp assembly for electrically connecting a metal structure to at least one grounding element, the clamp assembly comprising:
a base;
a main body having a structure contacting surface, the structure contacting surface including at least one piercing member; and
at least one clamping member configured to clamp the at least one grounding element between the base and main body and to clamp the base and main body to the metal structure when the at least one clamping member is tightened.

2. The clamp assembly according to claim 1, wherein the base includes a first conductor gripping member and the main body includes a second conductor gripping member that aligns with the first conductor gripping member such that a channel is formed, and wherein the channel is configured to receive the at least one grounding element.

3. The clamp assembly according to claim 1, wherein the at least one piercing member comprises a plurality of piercing members.

4. The clamp assembly according to claim 1, wherein the at least one piercing member comprises a single tooth.

5. The clamp assembly according to claim 1, wherein the at least one piercing member comprises a single tooth having a serrated distal end.

6. The clamp assembly according to claim 1, wherein the at least one piercing member includes a raised surface having an aperture therethrough.

7. The clamp assembly according to claim 1, wherein the at least one piercing member is monolithically formed from the main body.

8. A clamp assembly for electrically connecting a metal structure to at least one grounding element, the clamp assembly comprising:
a base;
a main body;
a bonding member having at least one piercing member, wherein the bonding member is coupled with the main body; and
at least one clamping member configured to clamp the at least one grounding element between the base and the main body and to clamp the base and main body to the metal structure when the at least one clamping member is tightened.

9. The clamp assembly according to claim 8, wherein the base includes a first conductor gripping member and the main body includes a second conductor gripping member that aligns with the first conductor gripping member top define a channel configured to receive the at least one grounding element.

10. The clamp assembly according to claim 8, wherein the at least one piercing member comprises a plurality of piercing members.

11. The clamp assembly according to claim 8, wherein the at least one piercing member comprises a single tooth.

12. The clamp assembly according to claim 8, wherein the at least one piercing member comprises a single tooth having a serrated distal end.

13. The clamp assembly according to claim 8, wherein the at least one piercing member includes a raised surface having an aperture therethrough.

14. The clamp assembly according to claim 8, wherein the at least one piercing member is monolithically formed from the bonding member.

15. A clamp assembly for electrically connecting a metal structure to at least one grounding element, the clamp comprising:
a main body having a grounding element connector and at least one piercing member, the grounding element connector being configured to receive the at least one grounding element and to secure the at least one grounding element to the main body, and the at least one piercing member being configured to pierce a coating on the metal structure; and
at least one clamping member configured to clamp the main body to the metal structure when the at least one clamping member is tightened.

16. The clamp assembly according to claim 15, wherein the at least one piercing member comprises a plurality of piercing members.

17. The clamp assembly according to claim 15, wherein the at least one piercing member comprises a single tooth.

18. The clamp assembly according to claim 15, wherein the at least one piercing member comprises a single tooth having a serrated distal end.

19. The clamp assembly according to claim 15, wherein the at least one piercing member includes a raised surface having an aperture therethrough.

20. The clamp assembly according to claim 15, wherein the at least one piercing member is monolithically formed from the main body.
